(19) United States
(12) Patent Application Publication
(10) Pub. No.: US 2024/0357650 A1
(43) Pub. Date: Oct. 24, 2024

(54) INFRASTRUCTURE AND PEER-TO-PEER (P2P) MEDIUM ACCESS SHARING

(71) Applicant: Apple Inc., Cupertino, CA (US)

(72) Inventors: Ahmad Reza HEDAYAT, Carlsbad, CA (US); Yong LIU, Campbell, CA (US); Qi WANG, Sunnyvale, CA (US); Lochan VERMA, Danville, CA (US); Tianyu WU, Monterey, CA (US); Jarkko L. KNECKT, Los Gatos, CA (US); Jinjing JIANG, Campbell, CA (US); Su Khiong YONG, Palo Alto, CA (US); Sidharth R. THAKUR, San Jose, CA (US)

(73) Assignee: Apple Inc., Cupertino, CA (US)

(21) Appl. No.: 18/630,481

(22) Filed: Apr. 9, 2024

Related U.S. Application Data
(60) Provisional application No. 63/461,173, filed on Apr. 21, 2023.

(51) Int. Cl. H04W 74/0816; H04L 5/00; H04W 74/08

(52) U.S. Cl. CPC H04W 74/0816; H04L 5/0053; H04W 74/0866

(57) ABSTRACT

Some embodiments include an apparatus, method, and computer program product for infrastructure and peer-to-peer (P2P) medium access sharing. Some embodiments enable an access point (AP) to assist associated stations (STAs) in accessing a channel. In some embodiments, an AP can receive a request for coordinated transmission for peer-to-peer (P2P) communications, determine a bandwidth available for use during a transmit opportunity (TXOP), and allocate, from the bandwidth, a first subset of one or more channels for infrastructure communications and a second subset of one or more channels for the P2P communications responsive to the request. The AP can transmit to a STA, a first signal corresponding to the second subset of one or more channels for the P2P communications, indicating that the second subset of one or more channels can be used for P2P communications during the TXOP.

### CROSS-REFERENCE TO RELATED APPLICATIONS

The present application claims the benefit of U.S. Provisional Patent Appl. No. 63/461,173, filed Apr. 21, 2023, which is incorporated herein by reference in its entirety.

### BACKGROUND

### Field

The described embodiments generally relate to infrastructure and peer-to-peer (P2P) access sharing in a wireless communications system.

### Related Art

Wireless communications systems support communications between an access point (AP) and a communications device such as a station (STA).

### SUMMARY

Some embodiments include a system, apparatus, article of manufacture, method, and/or computer program product and/or combinations and sub-combinations thereof for infrastructure and P2P medium access sharing.

In some embodiments, an access point (AP) can receive a request for coordinated transmission for peer-to-peer (P2P) communications. The AP can determine a bandwidth available for use during a transmit opportunity (TXOP). The AP can allocate, from the bandwidth a first subset of one or more channels for infrastructure communications and a second subset of one or more channels for the P2P communications. The AP can transmit to a station (STA), a first signal corresponding to the second subset of one or more channels for the P2P communications, indicating that the second subset of one or more channels can be used for P2P communications during the TXOP. In some embodiments, the AP can switch receive operations from the first subset of channels and the second subset of channels to only the first subset of channels after transmitting the first signal.

In some embodiments, the infrastructure communications can include a downlink (DL) physical protocol data unit (PPDU), and the first signal can include a first trigger frame (TF). In some embodiments, the coordinated transmission for P2P communications is based on coordinated-frequency-division multiple access (C-FDMA) and the first TF indicates a duration of the TXOP.

In some embodiments, the coordinated transmission for P2P communications can be based on coordinated-orthogonal frequency-division multiple access (C-OFDMA) and the first TF indicates a duration of a first preamble of the DL PPDU, enabling OFDM-symbol alignment with a second preamble of a P2P PPDU of the P2P communications. In some embodiments, the first TF can indicate an expected duration of a first acknowledgment (ACK) frame of the P2P communications, where the first ACK frame aligns with a second ACK frame of the DL PPDU.

In some embodiments, the infrastructure communications can include an uplink (UL) PPDU and the first signal can be a first TF. In some embodiments, the coordinated transmission for P2P communications can be based on C-FDMA and the first TF can indicate a duration of the TXOP.

In some embodiments, the coordinated transmission for P2P communications can be based on C-OFDMA and the first TF can indicate a duration of a first preamble of the UL PPDU, enabling OFDM-symbol alignment with a second preamble of a P2P PPDU of the P2P communications. In some embodiments, the first TF can indicate an expected duration of a first ACK frame of the P2P communications, where the first ACK frame aligns with a second ACK frame of the UL PPDU.

In some embodiments, a STA can transmit, to an AP, a request for coordinated transmission for P2P communications, and receive a first signal corresponding to a subset of one or more channels for the P2P communications. The first signal can indicate that the subset of one or more channels can be used for P2P communications during a TXOP. The STA can initiate the P2P communications using the subset of one or more channels. In some embodiments, the first signal can be a first TF. The STA can transmit a first Clear to Send (CTS) frame to the AP responsive to the first TF. Further, the STA can initiate the P2P communications in association with the transmission of the CTS frame. In some embodiments, the request for coordinated transmission for P2P communications can be based on C-FDMA, where the first TF can indicate a duration of a TXOP and the STA can conclude the P2P communications in accordance with the duration of the TXOP.

In some embodiments, the coordinated transmission for P2P communications can be based on C-OFDMA and the first TF can indicate a duration of a first preamble of a DL PPDU corresponding to infrastructure communications of the AP. The STA can initiate the P2P communications, including a second preamble that is in OFDM-symbol alignment with the duration of the first preamble. In some embodiments, the first TF can indicate an expected duration of an ACK frame of the P2P communications. The STA can transmit an ACK frame based on the expected duration.

In some embodiments, the first signal can be a first TF. The STA can transmit a first CTS frame to the AP. The STA can initiate the P2P communications in association with the transmission of the CTS frame. In some embodiments, the coordinated transmission for P2P communications can be based on C-FDMA and the first TF can indicate a duration of a TXOP. The STA can conclude the P2P communications in accordance with the duration of the TXOP.

In some embodiments, the coordinated transmission for P2P communications can be based on C-OFDMA, where the first TF can indicate a duration of a first preamble of an UL PPDU corresponding to infrastructure communications of the AP. The STA can initiate the P2P communications, including a second preamble that is in OFDM-symbol alignment with the duration of the first preamble. In some embodiments the first TF can indicate an expected duration of an ACK frame of the P2P communications and the STA can transmit an ACK frame based on the expected duration.

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system for infrastructure and peer-to-peer (P2P) medium access sharing, in accordance with some embodiments of the disclosure.

FIG. 2 illustrates a block diagram of an example wireless system for infrastructure and P2P medium access sharing, according to some embodiments of the disclosure.

FIG. 3 illustrates an example of a sequence diagram for downlink (DL) infrastructure and P2P medium access sharing, according to some embodiments of the disclosure.

FIG. 4 illustrates an example of DL infrastructure and P2P medium access sharing data flow, according to some embodiments of the disclosure.

FIG. 5 illustrates an example of DL infrastructure and P2P medium access sharing data flow where a communication method is coordinated-frequency-division multiple access (C-FDMA), according to some embodiments of the disclosure.

FIG. 6 illustrates an example of DL infrastructure and P2P medium access sharing data flow where a communication method is coordinated-orthogonal frequency-division multiple access (C-OFDMA), according to some embodiments of the disclosure.

FIG. 7 illustrates an example system for uplink (UL) infrastructure and P2P medium access sharing, in accordance with some embodiments of the disclosure.

FIG. 8 illustrates an example of a sequence diagram for UL infrastructure and P2P medium access sharing, according to some embodiments of the disclosure.

FIG. 9 illustrates an example of UL infrastructure and P2P medium access sharing data flow, according to some embodiments of the disclosure.

FIG. 10 illustrates an example of UL infrastructure and P2P medium access sharing data flow, according to some embodiments of the disclosure.

FIG. 11 is an example computer system for implementing some embodiments or portion(s) thereof.

FIG. 12 illustrates an example method for an access point (AP) performing infrastructure and P2P medium access sharing, according to some embodiments of the disclosure.

FIG. 13 illustrates an example method for a station (STA) performing infrastructure and P2P medium access sharing, according to some embodiments of the disclosure.

FIG. 14 illustrates an example of access sharing data flow, according to some embodiments of the disclosure.

FIG. 15 illustrates another example of access sharing data flow, according to some embodiments of the disclosure.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments include a system, apparatus, article of manufacture, method, and/or computer program product and/or combinations and sub-combinations thereof for infrastructure and P2P medium access sharing. In a network formed by an access point (AP) and multiple stations (STAs), there may be a need for peer-to-peer (P2P) communications between multiple STAs, in addition to infrastructure communications between the AP and one or more of the STAs. When P2P and infrastructure communications use a common channel, it is necessary to identify the terminal communicating using the channel to avoid interference. In a media access method called Enhanced Distributed Channel Access (EDCA), a terminal experiences a random time/delay before acquiring a transmission opportunity (TXOP), during which the terminal has the right to transmit data on the channel. Further, a WiFi wireless channel in the unlicensed spectrum may be shared with other devices, each performing a medium access procedure (e.g., the EDCA process), adding more channel address delay. For instance, when there are multiple STAs in the network, the STAs that engage in P2P communications (e.g., run P2P applications) compete for channel access with the AP, with which one or more of the STAs may be associated. The STAs may not be able to obtain a TXOP due to heavy contention for the medium. Several technologies allow the AP to share, with a STA, a TXOP that the AP has acquired.

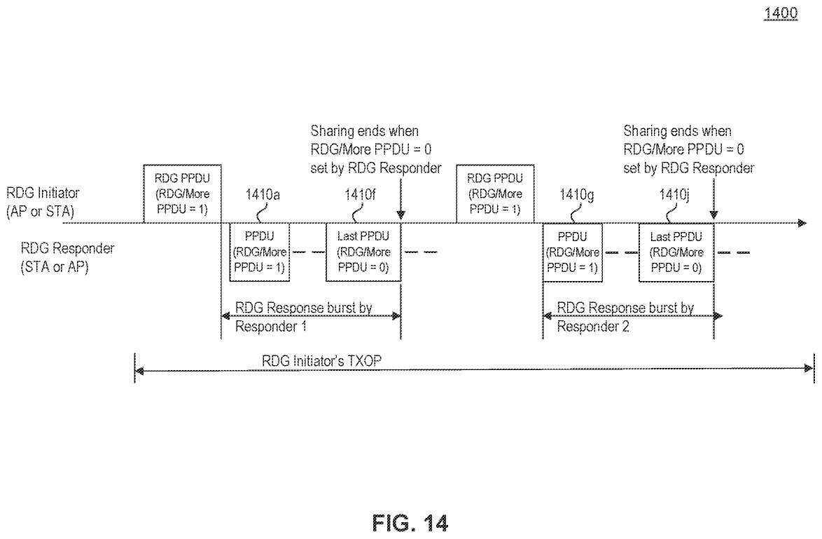

FIG. 14 illustrates an example access sharing data flow 1400, according to some embodiments of the disclosure. The access sharing data flow 1400 is one example of a TXOP sharing method called reverse direction grant (RDG). As shown in the access sharing data flow 1400, an RDG initiator (e.g., an AP or a STA) that obtained a TXOP, allows another device (e.g., another STA or AP) to initiate communications (e.g., transmission of data frames) during the TXOP. But, the transmissions 1410a-1410j may communicate in a narrow bandwidth (e.g., 20 MHZ).

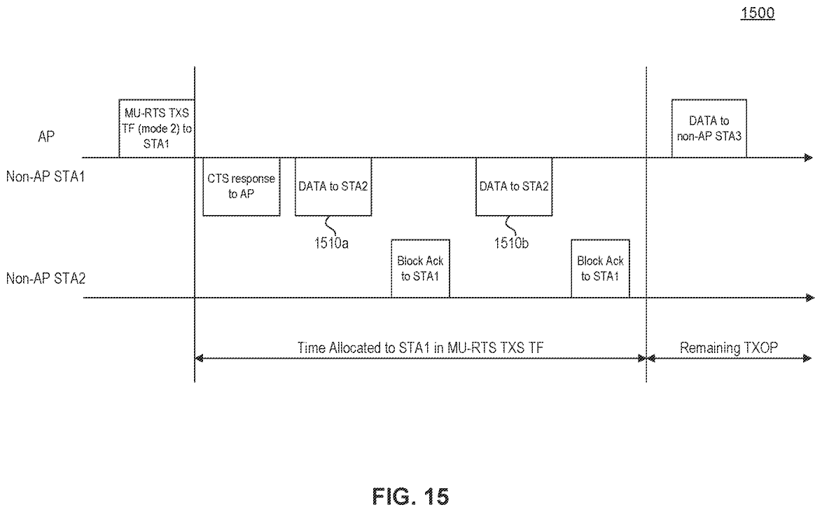

FIG. 15 illustrates another example access sharing data flow 1500, according to some embodiments of the disclosure. The access sharing data flow 1500 is another example of a TXOP sharing method called triggered TXOP-sharing (TXS). As shown in the access sharing data flow 1500, an AP that has obtained a TXOP allocates at least a portion of the TXOP duration to only one non-AP STA for initiating uplink (UL) or P2P communications during the TXOP. But, the transmissions 1510a-1510b may communicate in a narrow bandwidth (e.g., 20 MHZ).

The access sharing methods described above in FIG. 14 and FIG. 15 result in channel utilization loss when the STA to which the TXOP is shared can only communicate in a narrow bandwidth (e.g., 20 MHz shown as 1410 and 1510), even though the AP acquiring the TXOP can communicate in a wide bandwidth (e.g., 160 MHZ). In addition, the AP cannot use the entire period of TXOP obtained. Further, scaling to multiple P2P STAs (e.g., more pairs of P2P STAs) within a TXOP, more interframe space (IFS) and higher overhead would be incurred. Coexistence issues also remain where the unavoidable idle periods are prone to transmission by others.

Disclosed embodiments enable an AP to assist associated devices in accessing a channel. For example, an AP can be aware that one or more of the associated STAs/devices are running one or more P2P applications. When the AP secures a TXOP, e.g., to an unlicensed channel, the AP can reserve a frequency portion (e.g., one or more 20 MHz sub-bands or several resource units (RUs)) for the associated STA(s) to use. Thus, the STAs can benefit from the AP securing channel access rather than competing with the AP to access the channel.

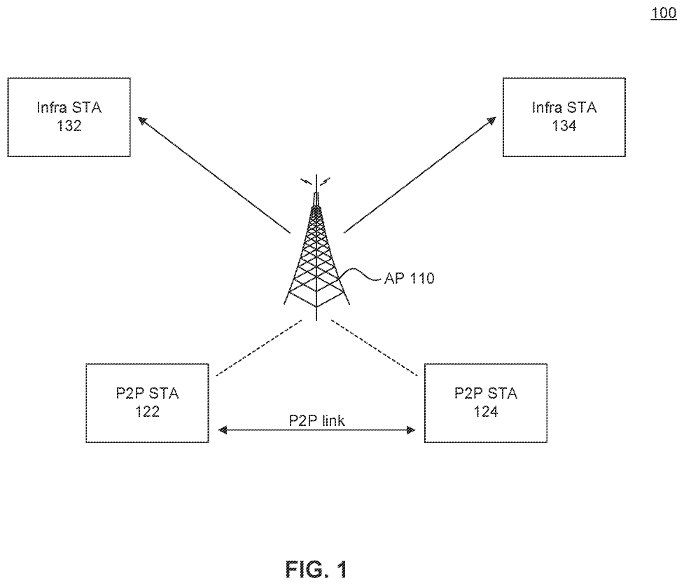

FIG. 1 illustrates an example system 100 for infrastructure and P2P access medium sharing, in accordance with some embodiments of the disclosure. Example system 100 is provided for the purpose of illustration only and is not limiting of the disclosed embodiments. For example, an AP 110, a P2P STA 122, a P2P STA 124, an infra STA 132, and an infra STA 134 form a network shown in the system 100. Non-AP stations (e.g., P2P STA 122, a P2P STA 124, an infra STA 132, and an infra STA 134) can be electronic devices that may include, but are not limited to, a cellular phone, a smartphone, a tablet, a personal digital assistant (PDA), or a laptop. In some embodiments, the P2P STA 122 can be the same/similar type of device as infra STA 132 and is capable of executing a P2P application. System 100 illustrates P2P STA 122 executing a P2P application while infra STA 132 is not executing a P2P application.

AP 110 can connect to a network (not shown) that may include, but is not limited to, any of or any combination of one or more local area networks (LANs), metropolitan area networks (MANs), wireless local area networks (WLANs), enterprise networks, and/or the Internet. In some embodiments, AP 110 may be a multi-link device (MLD), where AP 110 may include a more than one transceiver.

The P2P STA 122 and the P2P STA 124 can communicate with the AP 110 through respective infrastructure communications and also communicate with each other via P2P communications. The infra STA 132 and the infra STA 134 communicate with the AP 110, and the communications is called, in this disclosure, infrastructure communications, which is distinguished from P2P communications. Infrastructure communications can be downlink (DL) and/or uplink (UL). FIG. 1 shows a case in which the infrastructure communications are DL. In the system 100, the P2P STA 122 and the P2P STA 124 perform P2P communications during a TXOP obtained by the AP 110, and the AP 110 performs DL infrastructure communications with the infra STA 132 and/or the infra STA 134 during the TXOP. In this disclosure, communications in which an AP cooperates with a STA to support the STA's P2P communications are called coordinated communications.

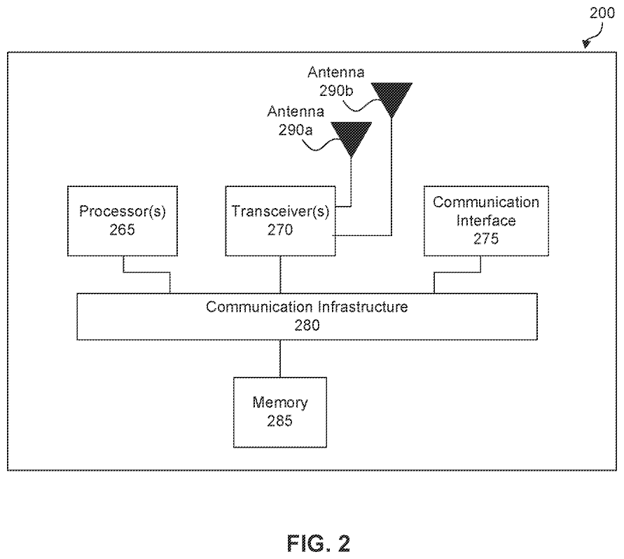

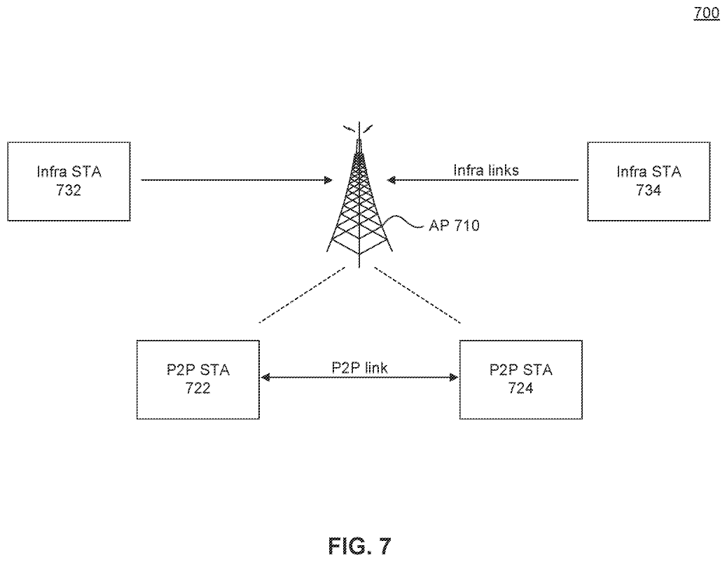

FIG. 2 illustrates a block diagram of an example wireless system 200 for infrastructure and P2P medium access sharing, according to some embodiments of the disclosure. For explanation purposes and not a limitation, FIG. 2 may be described with reference to elements from FIG. 1 and FIG. 7. For example, system 200 may be any of the electronic devices: the AP 110, the P2P STA 122, the P2P STA 124, the infra STA 132, the infra STA 134, an AP 710, a P2P STA 722, a P2P STA 724, an infra STA 732, an infra STA 734. System 200 includes one or more processors 265, transceiver(s) 270, communication interface 275, communication infrastructure 280, memory 285, and antenna 290. Memory 285 may include random access memory (RAM) and/or cache, and may include control logic (e.g., computer instructions) and/or data. One or more processors 265 can execute the instructions stored in memory 285 to perform operations enabling wireless system 200 to transmit and receive wireless communications, including the functions for infrastructure and P2P medium access sharing. In some embodiments, one or more processors 265 can be “hard coded” to perform the functions described herein. Transceiver(s) 270 transmits and receives wireless communications signals including wireless communications supporting infrastructure and P2P medium access sharing, according to some embodiments, and may be coupled to one or more antennas 290 (e.g., 290a, 290b). In some embodiments, a transceiver 270a (not shown) may be coupled to antenna 290a, and different transceiver 270b (not shown) can be coupled to antenna 290b. Communication interface 275 allows system 200 to communicate with other devices that may be wired and/or wireless. Communication infrastructure 280 may be a bus, interconnect, or other direct or indirect coupling. Antenna 290 may include one or more antennas that may be the same or different types.

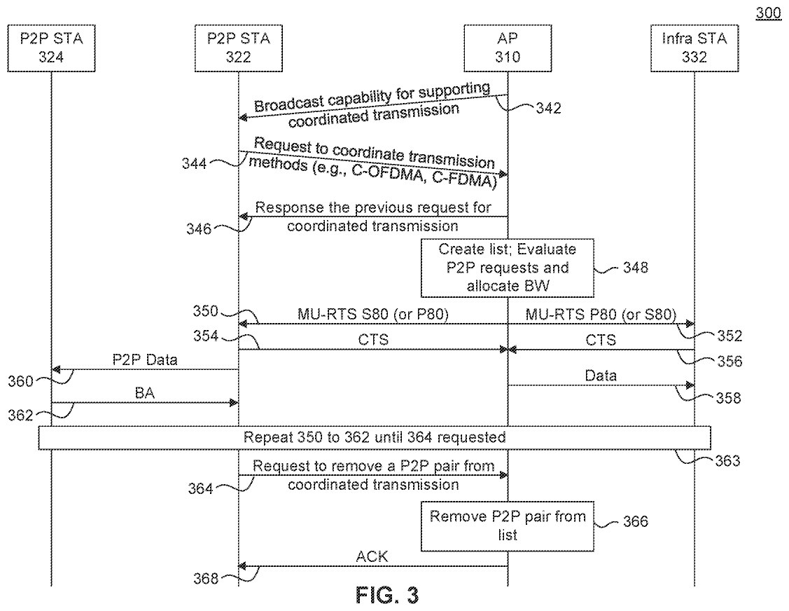

FIG. 3 illustrates an example of a sequence diagram 300 for downlink (DL) infrastructure and P2P medium access sharing, according to some embodiments of the disclosure. For explanation purposes and not a limitation, FIG. 3 may be described with reference to elements from FIG. 1. For example, an AP 310 may be the AP 110, a P2P STA 322 may be the P2P STA 122, a P2P STA 324 may be the P2P STA 124, and an infra STA 332 may be the infra STA 132. In sequence diagram 300, the P2P STA 322 and the P2P STA 324 perform P2P communications during a TXOP obtained by the AP 310, and the AP 310 performs DL infrastructure communications with the infra STA 332 during the TXOP.

In some embodiments, the communications can be performed in the order as shown. For convenience and not a limitation, the P2P communication exchanges may be described followed by infrastructure communication exchanges. The order of the communication exchanges can vary. For example, operation 352 may occur after operation 350, and so on.

At operation 342, the AP 310 broadcasts a capability for supporting coordinated transmissions. For simplicity and not a limitation, the broadcast is shown as being received at the P2P STA 322. However, associated STAs (e.g., infra STA 332) may also receive the broadcast. In some embodiments, the coordinated transmission methods include coordinated-frequency-division multiple access (C-FDMA) and coordinated-orthogonal frequency-division multiple access (C-OFDMA). The broadcast capability indicates C-FDMA or C-OFDMA, both of them, or neither of them. When the coordinated transmission method for DL or UL transmissions is C-FDMA, infrastructure PPDUs and P2P PPDUs do not have to have OFDM-symbol (OS)-alignment. In contrast, when the coordinated transmission method for DL or UL transmissions is C-OFDMA, infrastructure PPDUs and P2P PPDUs have OFDM-symbol (OS)-alignment.

At operation 344, the P2P STA 322 transmits a request to the AP 310 to request coordinated transmission methods during one or more TXOPs that the AP 310 would be the owner of, subject to the attributes carried in the request, such as the duration of the coordinated transmission. In some embodiments, the P2P STA 322 can use a Stream Classification Service (SCS) framework to make the request. In some embodiments, the P2P STA 322 can use SCS Quality of Service (QOS) Characteristics Element (QCE) to take advantage of one or more existing fields of the SCS or may use one or more new fields to make the request. In sequence diagram 300, the P2P STA 322 makes the request using the SCS QCE and an example of the SCS QCE settings is shown below in Table 1:

TABLE 1
Example SCS QCE Settings

| Fields | Values |
|---|---|
| QCE/Control Info/Direction | P2P |
| QCE/Control Info/P2P ID | An identifier known to two more STAs that |
| | are part of a P2P set |
| QCE/Control Info/Link ID | Set to a new value to indicate coordinated |
| | transmission |
| QCE/Min and QCE/Max | Set accordingly |
| service interval | |
| QCE/Min data rate | N/A (The P2P STA 322 sets its own data |
| | rate and P2P link adaptation) |
| QCE/Delay bound | Max delay that the P2P STA 322 expects |

In some embodiments, in addition to the fields described above, the P2P STA 322 may define the attributes of the request using new fields in the SCS QCE. In some embodiments, the P2P STA 322 can use a new optional field of “Next coordinated transmission expected,” which indicates whether a next coordinated transmission is expected (e.g., value=0) or not (e.g., value=1). In some embodiments, the P2P STA 322 can use a new optional field of “Transition to Primary channel expected,” which indicates whether a transition to Primary channel is expected (e.g., value=0) or not (e.g., value=1). In some embodiments, the P2P STA 322 can use a new optional field of “QCE/Peer STA identifier,” which indicates another P2P STA's (e.g., P2P STA 324's) identity information, including Media Access Control (MAC) address or any other identifier of the P2P STA 324. In some embodiments, an identifier for the P2P Set can be used. The identifier can be pre-defined, already pre-negotiated, and known to all the P2P STAs that belong to the same P2P Set (e.g., the second field in Table 1). Use of such an identifier may be advantageous as it does not disclose, to the AP, the identity of the P2P STAs involved in the P2P transmission. In some embodiments, a “QCE/Peer STA identifier” can be used by the AP 310 to identify the P2P STA 324 in addition to the P2P STA 322 in a User-Specific Info field. The User-Specific Info field can indicate which signals are or will be transmitted from the AP 310 to the P2P STA 322 (e.g., at operation 350). In some embodiments, the P2P STA 322 can use a new optional field of “QCE/Control Info,” indicating preferred transmission methods, including C-FDMA, C-OFDMA, or both. In some embodiments, the User-Specific Info field and the new optional field of “QCE/Control info” may be indicated in new fields of a multi-user (MU)-Request to Send (RTS) frame transmitted from AP 310 to the P2P STA 322 at operation 350. An MU-RTS frame is one variation of a trigger frame (TF). In some embodiments, the operations described using an MU-RTS frame can be replaced by one or more other TF types.

In some embodiments, the P2P STA 322 can transmit the request in response to the broadcast signal at 342. In some embodiments, P2P STA 322 can transmit the request at a predetermined RF frequency band determined by the nature of an application (e.g., a P2P application executing on P2P STA 322 and P2P STA 324) that uses the P2P communications.

At operation 346, the AP 310 receives the request for coordinated transmission and either accepts or rejects the request. The AP 310 transmits an acknowledgment response to the previous request for coordinated transmission to the P2P STA 322. If AP 310 agrees to the request, AP 310 reserves a wide channel and shares at least a portion (e.g., a sub-band of the wide channel) with the requesting P2P STA 322. A portion of the reserved wide channel also can be shared with infra STA 332. In some embodiments, AP 310 may reject the request. In this disclosure, a frame exchange related to the request performed at operations 344 and 346 is referred to as a frame exchange for scheduling coordinated transmission.

At operation 348, the AP 310 creates or updates a list of the P2P STAs or P2P set identifiers for the P2P communications. The AP 310 evaluates the requests from the P2P STAs, then allocates bandwidth (BW) for infrastructure communications and P2P communications. The list contains identifications of the P2P STAs (e.g., P2P STA 322 or a P2P Set identifier that identifies all of the STAs within a P2P Set, e.g., the second field in Table 1) for which a coordinated transmission request is accepted by the AP 310. In some embodiments, the list can also contain an identification of one or more other P2P STAs (e.g., P2P STA 324) with which the requesting P2P STA 322 communicates. The AP 310 evaluates the status of the P2P requests from the associated STAs and determines which P2P STAs (e.g., P2P pairs) to serve during DL or UL transmissions. For example, the AP 310 can decide to allocate a share of a subsequent TXOP obtained by the AP 310 for P2P communications. In some embodiments, AP 310 may determine not to allocate a share of a TXOP to the P2P STAs for P2P communications due to, for example, a basic service set (BSS) load that the AP 310 handles. In some embodiments, the P2P STAs that are not given a share of the TXOP may attempt P2P communications on their own, e.g., by contending for a channel.

To share the TXOP, the AP 310 allocates a first subset of channels for infrastructure communications and a second subset of channels for P2P communications. For example, for an instance in which the AP 310 has a total of 160 MHz BW of channels, the AP 310 can allocate 80 MHz BW for infrastructure communications, e.g., as a Primary 80 MHZ (P80) channel, and 80 MHz BW for P2P communications, e.g., as a Secondary 80 MHZ (S80) channel. In another example, when the AP 310 has access to 320 MHz BW, made up of 80 MHz or 40 MHz channels, the AP 310 can allocate one or more P160, P80, P40, or P20 channels for infrastructure communications and one or more S160, S80, S40, or S20 channels for P2P communications, respectively. Any allocation of the 320 MHz bandwidth can be configured. In some embodiments, the AP 310 (with a total bandwidth of 80 MHZ, 160 MHz, or 320 MHZ) may allocate one or more 20 MHz sub-channels within S40, S80 or S160 to one or more P2P sets of STAs, and assign the remaining one or more 20 MHZ sub-channels of S40, S80 or S160 for infrastructure communication (in addition to one or more primary channels).

The channel allocations described above are examples, and the channels may be allocated in different ways. For example, when the AP 310 has a total of 160 MHz BW of channels, the AP 310 can allocate 80 MHz BW for infrastructure communications as a Secondary 80 MHz (S80) channel and another 80 MHz BW for P2P communications as a Primary 80 MHz (P80) channel. In some embodiments, as an example and not a limitation, when the AP 310 has a total of 320 MHZ, 80 MHZ, or 40 MHz BW of channels, the AP 310 can allocate S160, S80, S40, or S20 channels for infrastructure communications and P160, P80, P40, or P20 channels for P2P communications, respectively. In some embodiments, the AP 310 (with total bandwidth of 80 MHz, 160 MHz, or 320 MHZ) may allocate one or more 20 MHz sub-channels within P40, P80 or P160 to one or more P2P sets of STAs, and assign the remaining 20 MHz sub-channels of P40, P80 or P160 for infrastructure communication (in addition to S40, S80, or S160). In other words, the primary and secondary channels can be interchangeable, and the primary and secondary channels may be swapped.

In some embodiments, the AP 310 may cancel the agreement of the request (e.g., operation 344) after its lifetime expiry. For example, the AP 310 may cancel the agreement of the request after execution of 350 to 362 for one or more instances. In some embodiments, after the cancellation, the P2P STA 322 may attempt to reinitiate the agreement by sending a new request (e.g., operation 344).

At operation 350, the AP 310 transmits a first MU-RTS frame to the P2P STA 322 that indicates the share of the TXOP allocated by the AP 310 at operation 348, S80 (e.g., 80 MHz bandwidth). In general, an MU-RTS frame is a request to send frames to the receiver. The AP 310, after performing channel access contention procedure, transmits the first MU-RTS frame to initiate a TXOP owned by the AP 310.

In some embodiments, the first MU-RTS frame can be a duplication of the second MU-RTS frame. However, the term first MU-RTS frame is used when focusing on the information aspect of the MU-RTS frame to a P2P STA.

At operation 354, the P2P STA 322 transmits a first Clear to Send (CTS) frame via the S80 channel, to the AP 310 in response to the first MU-RTS frame. In general, the CTS frame is permission to transmit frames to a sender of the CTS frame. In some examples, the P2P STA 322 can transmit a legacy CTS frame to the AP 310. In some examples, for coexistence and regulatory requirements, the P2P STA 324 may also transmit a CTS frame to the AP 310 (not shown).

At operation 360, the P2P STA 322 initiates P2P communications with the P2P STA 324 (e.g., transmit and/or receive P2P data). The P2P communications may be bi-directional or uni-directional. The P2P traffic is carried on the 20 MHz sub-channel identified in the first MU-RTS frame.

At operation 362, the P2P STA 324 transmits a block acknowledgment (BA) (or ACK) to the P2P STA 322 in response to P2P communications of operation 360.

At operation 352, the AP 310 transmits a second MU-RTS frame to the infra STA 332 for infrastructure communications, indicating P80 and 80 MHz available bandwidth. The second MU-RTS frame requests to send a DL physical protocol data unit (PPDU) from the AP 310 to the infra STA 332. In other words, concurrent (e.g., substantially the same time or at least partially overlapping in time) with transmitting the MU-RTS frame on the Primary 80 MHz channel, P80, the AP 310 transmits a duplicate version of the MU-RTS frame on Secondary 80 MHz channel, S80, in order to establish the TXOP owned by the AP 310 on S80. Transmission of the MU-RTS frame on P80 concurrently with the duplicate version MU-RTS frame on S80 (e.g., substantially at the same time), constitutes a single MU-RTS frame with bandwidth of 160 MHz covering P80 and S80.

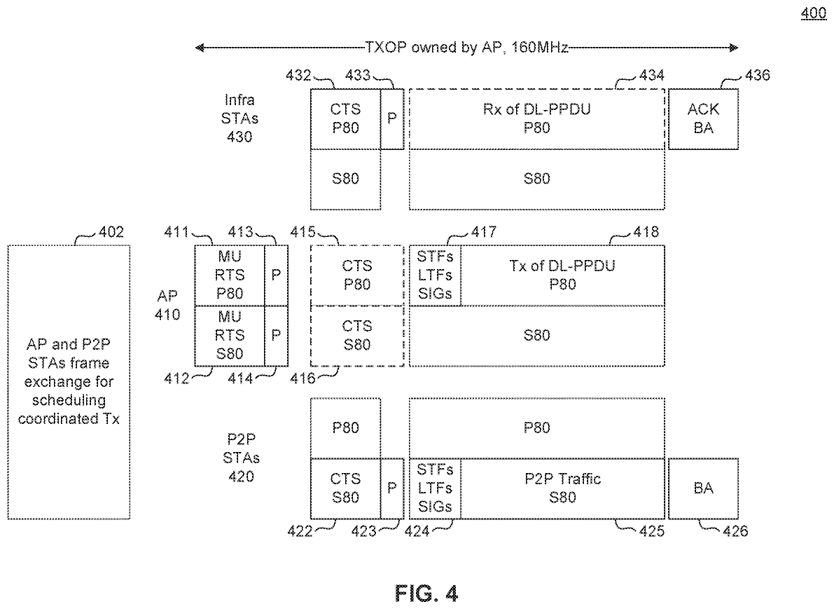

At operation 356, the infra STA 332 transmits, via the P80 channel as indicated in the second MU-RTS frame, a second CTS frame to the AP 310 in response to the second MU-RTS frame. The second CTS frame permits the transmission of DL-PPDUs from the AP 310 to the infra STA 332. In some embodiments, the second CTS frame and the first CTS frame may be received by the AP 310 concurrently (e.g., as shown in FIG. 4 for CTS frames 422 and 432).

At operation 358, the AP 310 transmits data via the P80 channel, namely the DL-PPDUs, to the infra STA 332 in response to the second CTS frame. In some embodiments, infra STA 332 can transmit ACK or BA (not shown) in response to the infrastructure communication of operation 358.

At operation 364, the P2P STA 322 transmits a request to remove the requesting P2P STA (e.g., P2P STA 322) and/or a P2P pair (e.g., P2P STA 322 and P2P STA 324) from the list for coordinated transmission. In some embodiments, the P2P STA 322 can transmit the request in response to a determination that there is no need for further P2P communications. In some embodiments, an application layer of the P2P STA 322 associated with the P2P communications may indicate no need for further P2P communications to the P2P STA 322.

At operation 366, the AP 310 removes the requesting P2P STA and/or the P2P pair/set from the list for coordinated transmission.

At operation 368, the AP 310 transmits an ACK to the P2P STA 322. The ACK indicates the removal of the P2P STA and/or P2P pair/set from the list.

FIG. 4 illustrates an example DL infrastructure and P2P medium access sharing data flow 400, according to some embodiments of the disclosure. For explanation purposes and not as a limitation, FIG. 4 may be described with reference to elements from FIG. 1 and FIG. 3. For example, an AP 410 may be represented by the AP 110 and/or the AP 310. P2P STAs 420 may be represented by: the P2P STA 122, the P2P STA 322, the P2P STA 124, and/or the P2P STA 324. Infra STAs 430 may be represented by the infra STA 132, the infra STA 332, and/or the infra STA 134. To avoid duplication, some explanations in FIG. 3 are referenced in the explanation of FIG. 4.

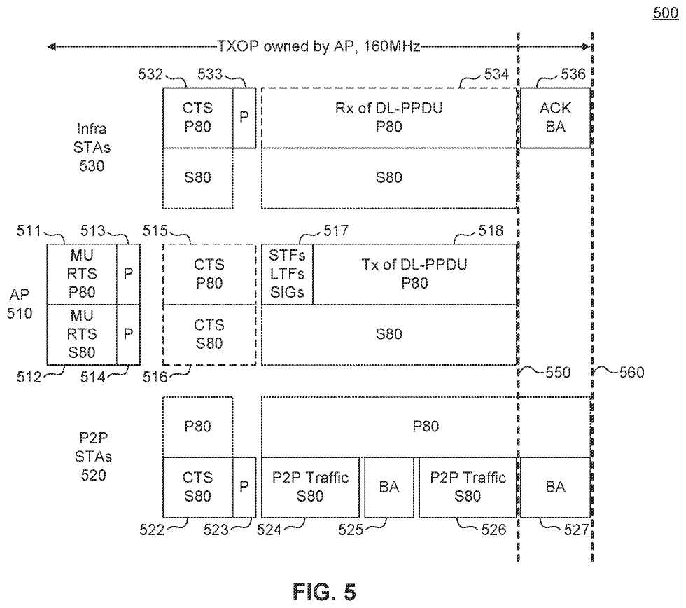

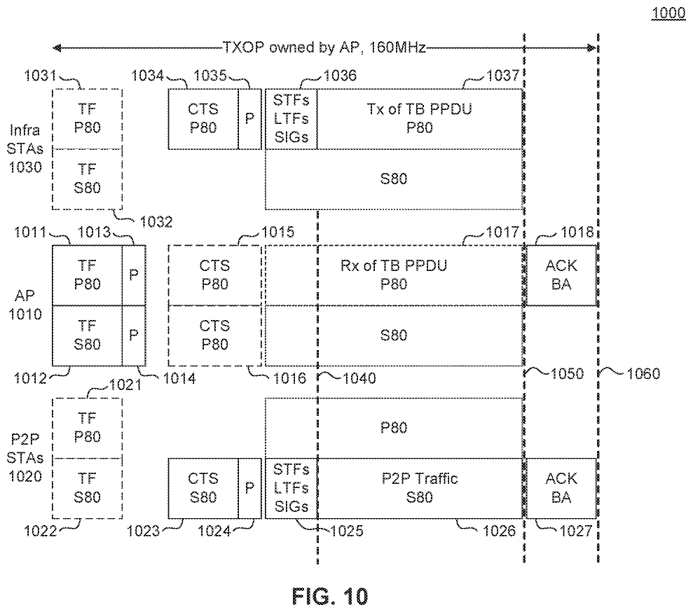

In FIGS. 4, 5, 6, 9, and 10, signals and data illustrated as rectangles drawn with solid lines indicate transmission flows, while signals and data illustrated as rectangles drawn with dashed lines indicate reception flows. Rectangles drawn with a combination of dots indicate no data communications unless otherwise noted. For example, CTS frames 415 and 416 demonstrate reception by the AP 410 of CTS frame 432 sent by infrastructure STAs 430 and CTS frame 422 sent by P2P STAs 420, respectively. For example, CTS frames 515 and 516 in FIG. 5, and CTS frames 1015 and 1016 in FIG. 10 also represent the reception by the corresponding AP, of the CTS frames sent from other devices.

In the data flow 400, the AP 410 reserves, as an example, a total of 160 MHz and allocates P80 to infrastructure communications and S80 to P2P communications during the TXOP allotted to (or owned by) the AP 410. In another example, the AP 410 may reserve a total of 160 MHz and allocate S80 to infrastructure communications and P80 to P2P communications during the TXOP owned by the AP 410. In other words, the primary and secondary channels can be interchangeable, and the primary and secondary channels may be swapped. The data flow 400 represents a data flow common to both C-FDMA and C-OFDMA coordinated transmission methods. In some embodiments, the AP 410 (with total bandwidth of 40 MHz, 80 MHZ, 160 MHz or 320 MHZ) may allocate one or more 20 MHZ sub-channels within S20, S40, S80 or S160 to one or more P2P sets of STAs, and assign the remaining 20 MHz sub-channels of S20, S40, S80 or S160 for infrastructure communication (in addition to P20, P40, P80, or P160).

At operation 402, AP 410 and P2P STAs 420 perform the frame exchange for scheduling coordinated transmission. The frame exchange of operation 402 can include operation 344 and operation 346 of FIG. 3.

The AP 410 transmits the second MU-RTS frame 411 to the infra STAs 430 on P80. The second MU-RTS frame 411 can be the operation 352 of FIG. 3. In some embodiments, a BW field in the second MU-RTS frame 411 may indicate 80 MHz PPDU. The first and second MU-RTS frames 411 and 412 can be transmitted concurrently (e.g., substantially at the same time or at least partially overlapping in time), where the transmission appears as one MU-RTS frame across the entire bandwidth of 160 MHz.

AP 410 transmits the first MU-RTS frame 412 to the P2P STAs 420 on S80. The first MU-RTS frame 412 can be the operation 350 of FIG. 3.

In some embodiments, a BW field in the second MU-RTS frame 411 may indicate P80, 80 MHz BW for DL infrastructure PPDUs. In some embodiments, the AP 410 may add signaling for P2P STAs 420 on S80 or one or more 20 MHz sub-channels in S80. For example, the signaling in the first MU-RTS frame 412 can identify S80, 80 MHz BW for P2P PPDUs, or one or more 20 MHz sub-channels of S80 for P2P PPDUs (e.g., P2P communications.)

In some embodiments, signaling in the first MU-RTS frame 412 may indicate that the expected CTS response (e.g., CTS frame 422) is on S80, and the second MU-RTS frame 411 may indicate that the expected CTS response (e.g., CTS frame 432) is on P80. In this way, the CTS frame 422 and the CTS frame 432 are not transmitted on the same channel.

In some embodiments, signaling in the first MU-RTS frame 412 may indicate additional power back-off (BO) signaling for P2P STAs 420. In some embodiments, the BO signaling may be indicated in a Common-info field or one or more User-Specific info fields. By indicating the BO signaling, AP 410 can prevent or reduce interference between P80 and S80 communications.

In the first MU-RTS frame 412, one or more User-Specific info fields indicate identity information of the P2P pair(s) (e.g., P2P STA 322 and P2P 324) of P2P STAs 420. In some embodiments, the identity information of only one P2P STA (e.g., P2P STA 322) of the P2P pair(s) (e.g., P2P STA 322 and P2P 324) may be indicated in the first MU-RTS frame 412. P2P communications between an identified P2P STA (e.g., P2P STA 322) and an unidentified P2P STA (e.g., P2P STA 324) can still be possible in this situation. Some regulatory requirements may prohibit a P2P STA that has not transmitted a CTS frame from initiating a data frame so that the P2P STA cannot transmit ACK/BA in P2P communications. If such regulatory requirements exist, it can be helpful to indicate the identity information of both P2P STAs in the first MU-RTS frame 412, e.g., so that both P2P STAs can transmit a CTS frame. In this way, both P2P STAs can perform channel sensing according to the communication protocol, and if the channel is clear, they both are able to transmit a CTS frame on S80 for channel reservation, and both P2P STAs of the P2P pair are eligible to initiate a data frame.

In some embodiments, AP 410 adds padding data 413 to the second MU-RTS frame 411 to provide enough time for infra STAs 430 to switch transceiver operations to P80. Padding data 414 is added to the first MU-RTS frame 412 to provide enough time for P2P STAs 420 to switch transceiver operations to S80 (e.g., from P80 to S80.)

In response to the second MU-RTS frame 411, infra STAs 430 transmit the CTS frame 432 to the AP 410 on P80. The CTS frame 432 can be the operation 356 of FIG. 3. AP 410 receives CTS frame 432 shown as the CTS frame 415 with dashed lines.

In response to the first MU-RTS frame 412, P2P STAs 420 transmit the CTS frame 422 to the AP 410 on S80. The CTS frame 422 can be the operation 354 of FIG. 3. AP 410 receives the CTS frame 422 shown as the CTS frame 416 with dashed lines.

In some embodiments, infra STAs 430 may add padding data 433 to the CTS frame 432, and/or P2P STAs 420 may add padding data 423 to the CTS frame 422 to provide enough time for the AP 410 to switch transceiver operations to receive on P80 (e.g., receive only on P80). The need for padding or the amount of padding for the CTS frame 422 or CTS frame 432 may be indicated using a new signal in the User-Specific Info field of the first MU-RTS frame 412 or the second MU-RTS frame 411, respectively. The CTS frame 422 and the CTS frame 432 can be encoded so that the CTS frame 422 and the CTS frame 432 generated by the infra STAs 430 and/or the P2P STAs 420 are bit-exact, with exact waveforms which are constructively added together over-the-air, on respective 20 MHZ-sub-channels. During the transmission of the CTS frame 422 or the CTS frame 432 and respective padding time(s), the AP 410 may switch a receiver of the AP 410's transceiver from a wider BW (e.g., 160 MHZ) to a narrower bandwidth (e.g., P80).

In response to the receipt of the CTS frame 415, the AP 410 transmits an Ultra High reliability (UHR) preamble 417 with the DL-PPDU 418 to the infra STAs 430 via P80. In some embodiments, UHR preamble 417 can include Short Training Fields (STFs), Long Training fields (LTFs), and/or Signal Fields (SIGs). The infra STAs 430 may receive the UHR preamble 417 and the DL-PPDU 418 as a DL-PPDU 434 shown with dashed lines. The infra STAs 430 transmit ACK/BA 436 to the AP 410 in response to receiving the DL-PPDU 434.

In response to the completion of the transmission of the CTS frame 422, a P2P STA (e.g., P2P STA 322) of the P2P STAs 420 exchanges a UHR preamble 424 and the P2P traffic 425 with another P2P STA (e.g., P2P STA 324) of the P2P STAs 420 via the indicated channel S80. The P2P STAs 420 transmit ACK or BA 426 to a respective P2P STA in response to the P2P traffic 425.

As described above, P2P STAs 420 can perform P2P communications while AP 410 is performing DL communications with infra STAs 430 using the TXOP period obtained by AP 410 and part of the BW allocated by AP 410. In FIG. 4, the AP 410 performs a coordinated transmission event with the P2P STAs 420 and infra STAs 430 by sharing a portion of a wide BW that the AP 410 acquired with one or more of the P2P STAs 420 and a remaining portion with the infra STAs 430.

In some embodiments, after the coordinated transmission event, the AP 410 may have one or more P2P STAs 420 return to the Primary channel (e.g., P80) for DL transmission. In some embodiments, AP 410 can set a value (e.g., value set to “1”) of a field, such as a “Transition to Primary channel expected” field of the SCS framework (e.g., via operation 346), so a requesting P2P STA (e.g., P2P STA 322) can be informed to return to the Primary channel after a coordinated transmission event. In some embodiments, a specific field of the User-Specific info field of the first MU-RTS frame 412 can be set (e.g., value set to “1”) that informs the requesting P2P STA to return to the Primary channel after a coordinated transmission event. In some embodiments, a P2P STA (e.g., P2P STA 322) of the P2P STAs 420 equipped with a scanning radio may tune the scanning radio to the Primary 20 MHz (P20) channel. The AP 410 can transmit an Initial Control Frame (ICF) to the P2P STA 322 of the P2P STAs 420, and add enough padding to provide enough time for the main radio of the P2P STA 322 to transition back to the Primary channel, P20.

FIG. 5 illustrates an example of DL infrastructure and P2P medium access sharing data flow 500 in which a communication method is C-FDMA, according to some embodiments of the disclosure. For explanation purposes and not a limitation, FIG. 5 may be described with reference to elements from FIG. 1, FIG. 3, and FIG. 4. For example, an AP 510 may include the AP 110, the AP 310, and the AP 410, P2P. STAs 520 may include the P2P STA 122, the P2P STA 322, P2P STA 124, the P2P STA 324, and the P2P STAs 420. Infra STAs 530 may include the infra STA 132, the infra STA 332, the infra STA 134, and the infra STAs 430. To avoid duplication, some explanations in FIG. 3 and FIG. 4 are referenced in the description of FIG. 5.

In the data flow 500, AP 510 allocates, as an example, a total of 160 MHz and allocates P80 to infrastructure communications and S80 to P2P communications during a TXOP owned by the AP 510. In another example, AP 510 may allocate a total of 160 MHZ, allocating S80 to infrastructure communications and P80 to P2P communications during a TXOP owned by the AP 510. In other words, the primary and secondary channels can interchangeable, and the primary and secondary channels may be swapped. Further, the division of BW also can be modified, such that more BW is allocated to P80 or S80. The data flow 500 represents a data flow of C-FDMA. Unless otherwise noted, the description of data flow 400, which is common to C-FDMA and C-OFDMA, is used in the description of data flow 500. In some embodiments, the AP 510 (with total bandwidth of 80 MHZ, 160 MHz or 320 MHZ) may allocate one or more 20 MHz sub-channels within S40, S80 or S160 to one or more P2P sets of STAs, and assign the remaining 20 MHz sub-channels of S40, S80 or S160 for infrastructure communication (in addition to P40, P80, or P160).

In the data flow 500, AP 510 and P2P STAs 520 perform the frame exchange for scheduling coordinated transmission before the TXOP period (e.g., operations 344 and 346 of FIG. 3). For examples where P2P communications occur on S20, S40, S80, or S160, a P2P PPDU (e.g., P2P Traffic 524) may not need to be aligned with a DL PPDU 518 (e.g., infrastructure communications).

AP 510 transmits the first MU-RTS frame 512 to the P2P STAs 520 on S80. The first MU-RTS frame 512 can correspond to operation 350 and the second MU-RTS frame 412 above.

In some embodiments, the User-Specific Info field of the first MU-RTS frame 512 may indicate a duration of, or end of, the TXOP owned by AP 510 (e.g., on 160 MHZ) to enable P2P STAs 520 to mark a conclusion of the P2P communications at the same time as the infrastructure communications. Including the duration of/end of the infra TXOP ensures that the P2P TXOP also ends by the same time, as shown by the dashed line 560.

In some embodiments, the User-Specific Info field of the first MU-RTS frame 512 may indicate a duration of/end of the DL PPDU 518 to enable P2P STAs 520 to align the end of a second (or subsequent) P2P Traffic 526 at the same time as the infrastructure communications. In other words, including the duration of, or end of, the DL PPDU 518 ensures that the second P2P Traffic 526 also ends by the time the DL PPDU 518 ends, e.g., as shown by the dashed line 550. In some embodiments, the User-Specific Info field of the first MU-RTS frame 512 may indicate an expected duration of the ACK/BA frame 527 for the P2P STAs 520 (or the maximum duration acknowledgment frame, for which ACK/BA 536 used by infra STAs 530 would also end) to assist P2P STAs 520 to conclude the P2P communications at the same time as the DL PPDU 518, shown by the dashed line 550.

In some embodiments, AP 510 may add padding data 514 to the first MU-RTS frame 512 to provide enough time for P2P STAs 520 to switch the respective transceivers to operate on S80 (e.g., operate only on S80.) In some embodiments, P2P STAs 520 may add enough padding to the first P2P Traffic 524 and/or the second P2P Traffic 526 to ensure that the duration of the P2P traffic frames will align with the end of the infra communications shown as dashed line 550.

In response to the first MU-RTS frame 512, P2P STAs 520 transmit a CTS frame 522 to the AP 510 on S80. The CTS frame 522 can correspond to operation 354 of FIG. 3. AP 510 receives the CTS frame 522 shown as CTS frame 516 with dashed lines.

In some embodiments, infra STAs 530 may add padding data 533 to the CTS frame 532, and/or P2P STAs 520 add padding data 523 to the CTS frame 522 to provide enough time for the AP 510 to switch transceiver operations to receive on P80 (e.g., receive only on P80.) The need for padding or the amount of padding for the CTS frame 522 or CTS frame 532 may be indicated using a new signal in the User-Specific Info field of the first MU-RTS frame 512 or the second MU-RTS frame 511, respectively. The CTS frame 522 and the CTS frame 532 can be encoded so that the CTS frame 522 and the CTS frame 532 generated by the infra STAs 530 and/or the P2P STAs 520 are bit-exact, with exact waveforms which are constructively added together over-the-air, on respective 20 MHZ-sub-channel. By doing so, during the transmission of the CTS frame 522 or the CTS frame 532, the AP 510 may have enough time to switch a receiver of the AP 510's transceiver from a wider BW (e.g., 160 MHZ) to a narrower bandwidth. (e.g., P80.)

In response to the completion of the transmission of the CTS frame 522, the P2P STAs 520 exchange the first P2P traffic 524 and the second P2P traffic 526. In some embodiments, the P2P STAs 520 can transmit a BA 525 and a BA 527 during or at the end of the P2P communication. P2P STAs 520 may be expected to use enough padding data to make sure that the duration of the P2P communications is confined within the TXOP duration as shown in dashed line 560. In some embodiments, the P2P STAs 520 may be expected to use enough padding data to make sure that the second P2P Traffic 526 ends at the same time with the DL PPDU 518 shown by the dashed line 550.

Turning to infrastructure communications, the AP 510 transmits the second MU-RTS frame 511 to the infra STAs 520 on P80. The second MU-RTS frame 511 can correspond to operation 352 and the second MU-RTS frame 411 described above. In some embodiments, AP 510 may add padding data 513 to the second MU-RTS frame 511 to provide enough time for infra STAs 530 to switch the respective transceivers to operate on P80 (e.g., operate only on P80.)

In response to the second MU-RTS frame 511, infra STAs 530 transmit a CTS frame 532 to the AP 510 on P80. The CTS frame 532 can correspond to operation 356 of FIG. 3. AP 510 receives the CTS frame 532 shown as CTS frame 515 with dashed lines. In some embodiments, infra STAs 530 may add padding data 533 to the CTS frame 532 to provide enough time for the AP 510 to switch transceivers to operate on P80 (e.g., operate only on P80.) The need for padding or the amount of padding for the CTS frame 532 may be indicated using a new signal in the User-Specific Info field of second MU-RTS frame 511.

In response to the receipt of the CTS frame 515, the AP 510 transmits a UHR preamble 517 with the DL PPDU 518 to the infra STAs 530 on P80. In some embodiments, the UHR preamble 517 can include STFs, LTFs, and SIGs. The infra STAs 530 receive the UHR preamble 517 and the DL PPDU 518 shown as a DL-FDMA PPDU 534 with dashed lines. The infra STAs 530 transmit ACK/BA 536 to the AP 510 in response to the receipt of the DL-FDMA PPDU 534.

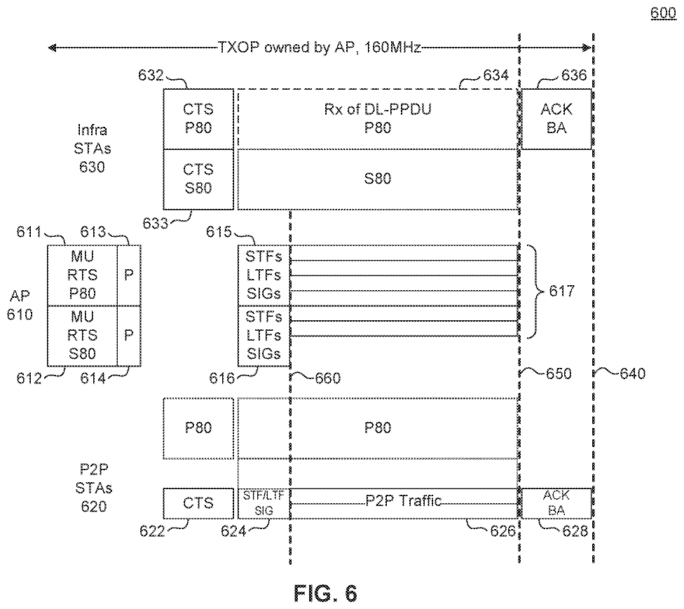

FIG. 6 illustrates an example of DL infrastructure and P2P medium access sharing data flow 600 where a communication method is C-OFDMA, according to some embodiments of the disclosure. For explanation purposes and not a limitation, FIG. 6 may be described with reference to elements from FIG. 1, FIG. 3, and FIG. 4. For example, an AP 610 may include the AP 110, the AP 310, and the AP 410. P2P STAs 620 may include the P2P STA 122, the P2P STA 322, P2P STA 124, the P2P STA 324, and the P2P STAs 420. Infra STAs 630 may include the infra STA 132, the infra STA 332, the infra STA 134, and the infra STAs 430. To avoid duplication, some explanations in FIG. 3 and FIG. 4 are referenced in the explanation in FIG. 6.

In some embodiments, AP 610 may allocate one or more contiguous 20 MHZ channel in S80. In the data flow 600, the AP 610 reserves a total of 160 MHz and allocates P80 for infrastructure communications. In addition, the upper 40 MHz channel of S80 is also allocated for infrastructure communications. The AP 610 allocates lower 40 MHZ channel of S80 for P2P communications during the TXOP owned by the AP 610. In some embodiments, the AP 610 (with total bandwidth of 80 MHZ, 160 MHz or 320 MHZ) may allocate one or more 20 MHz sub-channels within S40, S80 or S160 to one or more P2P sets of STAs, and assign the remaining 20 MHz sub-channels of S40, S80 or S160 for infrastructure communication (in addition to P40, P80, or P160).

The data flow 600 represents a data flow of C-OFDMA. Unless otherwise noted, the description of data flow 400, which is common to C-FDMA and C-OFDMA, is used in the description of data flow 600.

In the data flow 600, AP 610 and P2P STAs 620 perform the frame exchange for scheduling coordinate transmission before the TXOP period (e.g., operations 344 and 346 of FIG. 3.)

AP 610 transmits the second MU-RTS frame 611 to the infra STAs 630 on P80. The second MU-RTS frame 611 can correspond to operation 352 and the second MU-RTS frame 411 above.

AP 610 transmits the first MU-RTS frame 612 to the P2P STAs 620 on S80. The first MU-RTS frame 612 can correspond to operation 350 and the second MU-RTS frame 412 above.

In some embodiments, the User-Specific Info field of the first MU-RTS frame 612 may indicate a duration of/end of the TXOP owned by AP 610 on 160 MHz to enable P2P STAs 620 to mark a conclusion of the P2P communications at the same time as the infrastructure communications. In other words, knowing the duration of/end of an infrastructure TXOP can enable P2P STAs 620 (e.g., P2P STA 322) to end a P2P TXOP at the same time shown by the dashed line 640. This is similar to C-FDMA.

In some embodiments, the User-Specific Info field of the first MU-RTS frame 612 may indicate a duration of/end of the DL PPDU 617 to enable P2P STAs 620 to align the end of a P2P Traffic 626 at the same time as the infrastructure communications. In other words, including the duration of or end of the DL PPDU 617 can ensure that the P2P Traffic 626 also ends at the same time as the DL PPDU 617 shown by the dashed line 650. In some embodiments, the User-Specific Info field of the first MU-RTS frame 612 may indicate an expected (and/or maximum) duration of the ACK/BA frame 628 for the P2P STAs 620 (or, a duration of ACK/BA 636 used by infra STAs 630) to assist P2P STAs 620 to conclude the P2P communications at the same time as the DL PPDU 617 shown by the dashed line 650. While this is optional in C-FDMA, the alignment shown by dashed line 650 may be needed to achieve OFDM-symbol alignment for C-OFDMA. In some embodiments, P2P STAs 620 may add enough padding to the P2P Traffic 626 to ensure that the duration of the P2P traffic frames will align with the end of the infra communications shown as dashed line 650.

In data flow 600, additional signaling is needed to ensure P2P preambles (e.g., a UHR preamble 624) is OFDM-symbol aligned with infrastructure preambles (e.g., a UHR preamble 615.) For example, new signaling in the first MU-RTS frame 612 can provide information of a duration of a UHR preamble 615 (e.g., a number of LTFs) that help P2P STAs 620 align the UHR preamble 624 with the UHR preamble 615. The alignment is shown as a dashed line 660. In some embodiments, the duration of the UHR preamble 615 may be indicated by a number of LTFs in the UHR Preamble 615. In some embodiments, the duration of the UHR preamble 615 may be indicated by a number of LTFs, STFs, and/or SIGs in the UHR preamble 615. The alignment shown by dashed line 660 is needed to achieve OFDM-symbol alignment for C-OFDMA.

In some embodiments, AP 610 may add padding data 614 to the first MU-RTS frame 612 to provide enough time for P2P STAs 620 to switch transceiver operation to the lower 40 MHz of S80 (e.g., operate only on S40.)

In response to the second MU-RTS frame 611, infra STAs 630 can transmit a CTS frame 632 to the AP 610 on P80. In some embodiments, infra STAs 630 can transmit a CTS 633 to the AP 610 on S80 for example, to reserve the upper 40 MHz of S80. The CTS frames 632 and 633 can correspond to operation 356 of FIG. 3.

In response to the first MU-RTS frame 612, P2P STAs 620 transmit a CTS frame 622 to the AP 610 on lower 40 MHz channel of S80. The CTS frame 622 can correspond to operation 354 of FIG. 3.

In response to the receipt of the CTS frame 632, the AP 610 transmits the UHR preamble 615 with the DL PPDU 617 to the infra STAs 630 on P80 and a UHR preamble 616 to the infra STAs 630 and the P2P STAs on the upper 40 MHz of S80. In some embodiments, the AP 610 may transmit DL PPDU 617 to the infra STAs 630 on upper 40 MHz of S80. The UHR preamble 615 may include STFs, LTFs, and SIGs. In some embodiments, the infra STAs 630 can receive the UHR preamble 615 and the DL PPDU 617 shown as a DL PPDU 634 with dashed lines. The infra STAs 630 transmit ACK/BA 636 to the AP 610 in response to the receipt of the DL PPDU 634.

In response to the completion of the transmission of the CTS frame 622, the P2P STAs 620 exchange the UHR preamble 624 with the P2P traffic 626 on the lower 40 MHZ of the S80. In some embodiments, the P2P STAs 620 can transmit an ACK/BA 628 at the end of the P2P communication. P2P STAs 620 may be expected to use enough padding data to align the first ACK/BA 628 with the second ACK/BA 636. In some embodiments, the P2P STAs 620 may initiate the P2P communications with the UHR preamble 624 with a duration adjusted based on the duration of the UHR preamble 615 indicated in the first MU-RTS frame 612. In other words, a first TF (e.g., MU-RTS frame 612) can include a duration of one or more components of the set of preambles of signaling fields or training fields (e.g., 615, 616) of the DL PPDU 617 enabling OFDM-symbol alignment with a second preamble (e.g., 624) of a P2P PPDU (e.g., 626) of the P2P communications.

In some embodiments, the AP 610 may need to reserve guard resource units (RUs) on P80 and/or on S80 to protect P2P traffic (PPDU) 626 from unwanted out-of-band emission that could cause interference.

FIG. 7 illustrates an example system 700 for UL infrastructure and P2P medium access sharing, in accordance with some embodiments of the disclosure. Example system 700 is provided for the purpose of illustration only and is not limiting of the disclosed embodiments. For explanation purposes and not a limitation, FIG. 7 may be described with reference to elements from FIG. 1. For example, an AP 710 may be the AP 110, a P2P STA 722 may be the P2P STA 122, a P2P STA 724 may be the P2P STA 124, an infra STA 732 may be the infra STA 132, and an infra STA 734 may be the infra STA 134. The AP 710, the P2P STA 722, the P2P STA 724, the infra STA 732, and the infra STA 734 form a network shown in the system 700. The P2P STA 722 and the P2P STA 724 communicate with the AP 710 and also communicate with each other via P2P communications via a P2P link. The infra STA 132 and the infra STA 134 communicate with the AP 110 via infrastructure communications. FIG. 7 shows the case where the infrastructure communications are UL. In system 700, the P2P STA 722 and the P2P STA 724 perform P2P communications during a TXOP obtained by the AP 710, and the AP 710 performs UL infrastructure communications with the infra STA 732 or STA 734 during the TXOP.

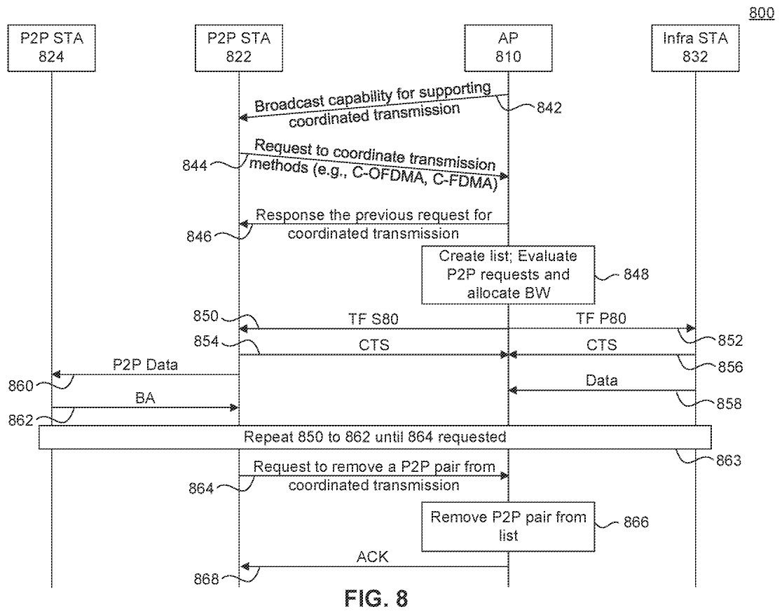

FIG. 8 illustrates an example of a sequence diagram 800 for UL infrastructure/P2P access infrastructure and P2P medium access, according to some embodiments of the disclosure. For explanation purposes and not a limitation, FIG. 8 may be described with reference to elements from FIG. 7. For example, an AP 810 may be the AP 710, a P2P STA 822 may be the P2P STA 722, a P2P STA 824 may be the P2P STA 724, and an infra STA 832 may be the infra STA 732. In sequence diagram 800, the P2P STA 822 and the P2P STA 824 perform P2P communications during a TXOP obtained by the AP 810, and the AP 810 performs UL infrastructure communications with the infra STA 832 during the TXOP.

The description of the part of the operations in FIG. 8 is similar to the operations in FIG. 3. In order to avoid duplicate explanations, the differences from the operations described in FIG. 3 are included below.

At operation 850, the AP 810 transmits, by using S80 channel, a first trigger frame (TF) to the P2P STA 822, based on operation 848. In general, a TF is a trigger to cause a receiver to transmit frames to the sender of the TF. In some embodiments, the first TF can contain further information utilized for the coordinated transmission. Since the MU-RTS frame is a variation of the TF, the characteristics of the MU-RTS frame described so far apply equally to a TF. In this disclosure, both the MU-RTS frame and the TF may be referred to as signals that enable the P2P STA to initiate P2P communications. The AP 810 transmits, after performing channel access contention procedure, the first TF in order to initiate the TXOP owned by the AP 810.

At operation 852, the AP 810 transmits, a second TF to the infra STA 832 for infrastructure communications indicating P80 and 80 MHz available bandwidth. The second TF triggers the infra STA 332 to send a UL PPDU to the AP 810. In other words, at the same time (e.g., substantially the same time) of transmitting the TF at the Primary 80 MHz channel, P80, the AP 310 transmits a duplicated version of the TF on Secondary 80 MHz channel, S80, in order to establish the TXOP owned by the AP 810 on the S80. The transmission of the TF on P80 and its duplicated version on S80 at the same time, constitutes a single TF with bandwidth of 160 MHz covering P80 and S80.

At operation 858, by using P80 channel, the infra STA 832 transmits data of UL PPDUs to the AP 810 in response to the second TF. In some embodiments, the AP 810 transmits ACK or BA in response to the infra STA 832 corresponding to the infrastructure communication.

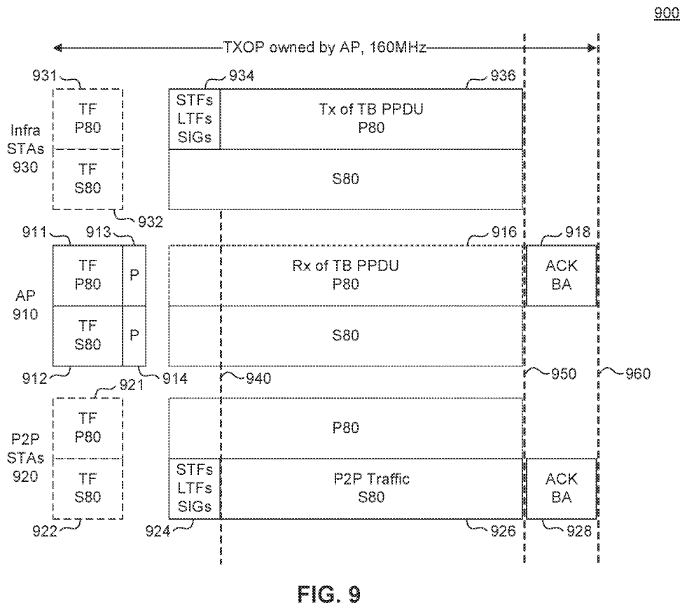

FIG. 9 illustrates an example of UL infrastructure and P2P medium access sharing data flow 900, according to some embodiments of the disclosure. For explanation purposes and not a limitation, FIG. 9 may be described with reference to elements from FIG. 7 and FIG. 8. For example, an AP 910 may be the AP 710, and the AP 810. P2P STAs 920 may be the P2P STA 722, the P2P STA 822, P2P STA 724, and the P2P STA 824. Infra STAs 930 may include the infra STA 732, the infra STA 832, and the infra STA 734. To avoid duplication, some explanations in FIG. 8 and FIG. 3 are referenced in the explanation in FIG. 9.

In the data flow 900, AP 910 allocates a total of 160 MHz and allocates P80 for infrastructure communications and S80 for P2P communications during the TXOP owned by the AP 910. In some embodiments, AP 910 allocates sub-channel of S80 to the P2P communications. The data flow 900 represents a data flow of C-FDMA or C-OFDMA. Unless otherwise noted, the description of data flow 400, which is common to C-FDMA and C-OFDMA, is used for the description of data flow 900. In some embodiments, AP 910 schedules RUs for infra STAs 930. In some embodiments, the AP 910 (with total bandwidth of 80 MHz, 160 MHz or 320 MHZ) may allocate one or more 20 MHz sub-channels within S40, S80 or S160 to one or more P2P sets of STAs, and assign the remaining 20 MHz sub-channels of S40, S80 or S160 for infrastructure communication (in addition to P40, P80, or P160).

In the data flow 900, as well as the data flow 400, AP 910 and P2P STAs 920 perform the frame exchange for scheduling coordinate transmission before the TXOP period.

AP 910 transmits the TF 911 to the infra STAs 930 and the P2P STAs 920 on P80. The TF 911 can correspond to operation 852 above. The TF 911 is received by the infra STAs 930 as the TF 931 drawn with dashed lines and by the P2P STAs 920 as the TF 921 drawn with dashed lines.

AP 910 transmits the TF 912 to the P2P STAs 920 on S80. The TF 912 can correspond to operation 850 above. The TF 911 is received by the infra STAs 930 as the TF 932 drawn with dashed lines and by the P2P STAs 920 as the TF 922 drawn with dashed lines.

In some embodiments, the User-Specific Info field of the first TF 912 may indicate a duration of/end of the TXOP owned by AP 910 on 160 MHz to enable P2P STAs 920 to mark a conclusion of the P2P communications at the same time as the infrastructure communications. In other words, including the duration of/end of the infra TXOP can ensure that the P2P TXOP also ends at the same time shown by the dashed line 960. This applies to both C-FDMA and C-OFDMA.

In some embodiments, the User-Specific Info field of the first TF 912 may indicate a duration of/end of a trigger-based (TB) PPDU 936 to enable P2P STAs 920 to align the end of a P2P Traffic 926 at the same time as the infrastructure communications. In other words, including the duration of/end of the TB PPDU 936 can ensure that the P2P Traffic 926 also ends at the same time with the TB PPDU 936 shown by the dashed line 950. In some embodiments, the User-Specific Info field of the first TF 912 may indicate an expected (and/or maximum allowed) duration of the ACK/BA frame 928 for the P2P STAs 920 (or, a duration of ACK/BA 918 used by infra STAs 930) to assist P2P STAs 920 to conclude the P2P Traffic 926 at the same time as the TB PPDU 936 shown by the dashed line 950. In some embodiments, P2P STAs 920 may add enough padding to the P2P Traffic 926 to ensure that the duration of the P2P traffic frames will align with the end of the infra communications shown as dashed line 950. If the coordinated transmission for the P2P communications is based on C-FDMA, the alignment shown by dashed line 950 is optional. If the coordinated transmission for the P2P communications is based on C-OFDMA, the alignment shown by dashed line 950 is needed to achieve OFDM-symbol alignment.

In some embodiments, in data flow 900, additional signaling may be needed to ensure P2P PPDUs (e.g., P2P Traffic 926) is OFDM-symbol aligned with TB PPDUs (e.g., received TB PPDU 936.) For example, new signaling in a first TF 912 can provide information of a duration of a UHR preamble 934 (e.g., a number of LTFs) that help P2P STAs 920 align a UHR preamble 924 with the UHR preamble 934. The alignment is shown as a dashed line 940. In some embodiments, the duration of the UHR preamble 934 may be indicated by a number of LTFs in the UHR Preamble 934. In some embodiments, the duration of the UHR preamble 934 may be indicated by a number of LTFs, STFs, and/or SIGs in the UHR preamble 934. If the coordinated transmission for the P2P communications is based on C-FDMA, the alignment shown by dashed line 940 is optional. If the coordinated transmission for the P2P communications is based on C-OFDMA, the alignment shown by dashed line 940 is needed to achieve OFDM-symbol alignment.

In some embodiments, P2P STAs 920 may ignore indicated attributes in the User-Specific Info fields of the first TF 912. In some embodiments, the P2P STAs 920 may decide their Modulation and Coding Scheme (MCS) and other physical (PHY) attributes. In some embodiments, the P2P STAs 920 may add signaling in SIGs (U-SIGs) of the UHR preamble 934 to control the decided MCS attributes. In some embodiments, AP 910 may reserve the User-Specific Info fields, which are not applicable to the P2P STAs 920.

In some embodiments, P2P STAs 920 may use specified attributes in a TF/Commons info field to generate a PPDU whose legacy and UHR STF/LTF have the same length/duration and number of OFDM symbols as the TB PPDU 936 transmitted by the infra STAs 930.

In some embodiments, the User-Specific Info field of the first TF 912 may indicate information for power control for the P2P STAs 920, which requires further power back-off defined in a baseline of the communication protocol.

In some embodiments, AP 910 may add padding data 913 to the second TF 911 and padding data 914 to the first TF 912 to provide enough time for P2P STAs 920 to switch operation of respective transceivers to operate on S80 (e.g., operate only on S80.)

In response to the receipt of the TF 931, the infra STAs 930 transmit the UHR preamble 934 with the TB PPDU 936 to the AP 910 on P80. AP 910 receives the UHR preamble 934 with the TB PPDU 936 as a TB PPDU 916. In response to the receipt of the TB PPDU 916, the AP 910 transmits the ACK/BA 918 to the infra STAs 930.

In response to the receipt of the first TF 912, P2P STAs 920 transmit the UHR preamble 924 with P2P traffic (PPDU) 926 on S80. In some embodiments, the P2P STAs 920 can transmit the ACK/BA 928 at the end of the P2P communication, P2P Traffic 926. P2P STAs 920 may be expected to use enough padding data to make sure that the ACK/BA 928 aligns with the ACK/BA 918. In some embodiments, the P2P STAs 920 may initiate the P2P communications with the UHR preamble 924 with a duration adjusted based on the duration of the UHR preamble 934 indicated in the first TF 912.

FIG. 10 illustrates an example of UL infrastructure and P2P medium access sharing data flow 1000, according to some embodiments of the disclosure. For explanation purposes and not a limitation, FIG. 10 may be described with reference to elements from FIG. 7 and FIG. 8. For example, an AP 1010 may be the AP 710, and the AP 810. P2P STAs 1020 may be the P2P STA 722, the P2P STA 822, P2P STA 724, and the P2P STA 824. Infra STAs 1030 may include the infra STA 732, the infra STA 832, and the infra STA 734. To avoid duplication, some explanations in FIG. 8 and FIG. 3 are referenced in the explanation in FIG. 10.

In the data flow 1000, AP 1010 allocates a total of 160 MHz and allocates P80 for infrastructure communications and S80 for P2P communications during the TXOP owned by the AP 1010. The data flow 1000 represents a data flow of C-FDMA or C-OFDMA. Unless otherwise noted, the description of data flow 400, which is common to C-FDMA and C-OFDMA, is also used to the description of data flow 1000. In some embodiments, the AP 1010 (with total bandwidth of 80 MHz, 160 MHz or 320 MHz) may allocate one or more 20 MHz sub-channels within S40, S80 or S160 to one or more P2P sets of STAs, and assign the remaining 20 MHz sub-channels of S40, S80 or S160 for infrastructure communication (in addition to P40, P80, or P160).

In the data flow 1000, as well as the data flow 400, AP 1010 and P2P STAs 1020 perform the frame exchange for scheduling coordinate transmission before the TXOP period.

AP 1010 transmits the second TF 1011 to the infra STAs 1030 and the P2P STAs 1020 on P80. The second TF 1011 can correspond to operation 852 above. The second TF 1011 is received by the infra STAs 1030 as the TF 1031 and by the P2P STAs 1020 as the TF 1021. In some embodiments, a BW field in the second TF 1011 indicates 80 MHZ PPDU. In some embodiments, the User-Specific Info field of the second TF 1011 indicates assigned 80 MHz (P80) and infra STAs 1030 operate on P80 only, as if TB PPDU 1037 is an 80 MHz PPDU.

AP 1010 transmits the first TF 1012 to the P2P STAs 1020 and the infra STAs 1030 on S80. The first TF 1012 can correspond to operation 850 above. The first TF 1012 is received by the infra STAs 1030 as the TF 1032 and by the P2P STAs 1020 as the TF 1022. In some embodiments, a BW field in the first TF 1012 indicates 80 MHz PPDU.

In some embodiments, the User-Specific Info field of the first TF 1012 may indicate a duration of/end of the TXOP owned by AP 1010 on 160 MHz to enable P2P STAs 1020 to mark a conclusion of the P2P communications at the same time as the infrastructure communications. In other words, including the duration of/end of the infra TXOP can ensure that the P2P TXOP also ends at the same time shown by the dashed line 1060. This applies to both C-FDMA and C-OFDMA.

In some embodiments, the User-Specific Info field of the first TF 1012 may indicate a duration of/end of a TB PPDU 1037 to enable P2P STAs 1020 to align the end of a P2P Traffic 1026 at the same time as the infrastructure communications. In other words, including the duration of or end of the TB PPDU 1037 can ensure that the P2P Traffic 1026 also ends at the same time with the TB PPDU 1037 shown by the dashed line 1050. In some embodiments, the User-Specific Info field of the first TF 912 may indicate an expected duration of the ACK/BA frame 1027 for the P2P STAs 1020 (or, a duration of ACK/BA 1018 used by infra STAs 1030) to assist P2P STAs 1020 to conclude the P2P Traffic 1026 at the same time as the TB PPDU 1037 shown by the dashed line 1050. If the coordinated transmission for the P2P communications is based on C-FDMA, the alignment shown by dashed line 1050 is optional. If the coordinated transmission for the P2P communications is based on C-OFDMA, the alignment shown by dashed line 1050 is needed to achieve OFDM-symbol alignment. In some embodiments, P2P STAs 1020 may add enough padding to the P2P Traffic 1026 to ensure that the duration of the P2P traffic frames will align with the end of the infra communications shown as dashed line 1050.

In some embodiments, in data flow 1000, additional signaling may be needed to ensure P2P PPDUs (e.g., P2P Traffic 1026) is OFDM-symbol aligned with TB PPDUs (e.g., received TB PPDU 1037.) For example, new signaling in the first TF 1012 can provide information of a duration of a UHR preamble 1036 (e.g., a number of LTFs) that help P2P STAs 1020 align a UHR preamble 1025 with the UHR preamble 1036. The alignment is shown as a dashed line 1040. In some embodiments, the duration of the UHR preamble 1036 may be indicated by a number of LTFs in the UHR Preamble 1036. In some embodiments, the duration of the UHR preamble 1036 may be indicated by a number of LTFs, STFs, and/or SIGs in the UHR preamble 1036. If the coordinated transmission for the P2P communications is based on C-FDMA, the alignment shown by dashed line 1040 is optional. If the coordinated transmission for the P2P communications is based on C-OFDMA, the alignment shown by dashed line 1040 is needed to achieve OFDM-symbol alignment.

In some embodiments, the User-Specific Info field of the first TF 1012 may indicate that the P2P traffic 1026 is on S80 and not on the part of the TB PPDU 1037.

In some embodiments, AP 1010 may add padding data 1013 to the second IF 1032 and padding data 1014 to the first TF 1012 to provide enough time for P2P STAs 1020 to switch only to S80.

In some embodiments, the User-Specific Info field of the first TF 1012 may indicate information for power control for the P2P STAs 1020, which requires further power back-off defined in a baseline of the communication protocol.

In response to the second TF 1011, infra STAs 1030 transmit a CTS frame 1034 to the AP 1010 on P80. The CTS frame 1034 can correspond to operation 356 above. AP 1010 receives the CTS frame 1015 in response to the transmission.

In response to the first TF 1012, P2P STAs 1020 transmit a CTS frame 1023 to the AP 1010 on S80. The CTS frame 1022 can correspond to operation 354 above. AP 1010 receives the CTS frame 1016 in response to the transmission.

In some embodiments, infra STAs 1030 may add padding data 1035 to the CTS frame 1034, and/or P2P STAs 1020 may add padding data 1024 to the CTS frame 1023 to provide enough time for the AP 1010 to switch transceiver operations to receive on P80 (e.g., receive only on P80.) The need for padding or the amount of padding for the CTS frame 1023 or CTS frame 1034 may be indicated using a new signal in the User-Specific Info field of the first TF 1011 or second TF 1010, respectively. The CTS frame 1023 and the CTS frame 1034 can be encoded so that the CTS frame 1023 and the CTS frame 1034 generated by the infra STAs 1030 and/or the P2P STAs 1020 are bit-exact, with exact waveforms which are constructively added together over-the-air, on respective 20 MHZ-sub-channel. By doing so, during the transmission of the CTS frame 1023 or the CTS frame 1034, the AP 1010 may have enough time to switch a receiver of the AP 1010's transceiver from a wider BW (e.g., 160 MHZ) to a narrower bandwidth. (e.g., P80).

In some embodiments, in response to the receipt of the CTS frame 1015 and the CTS frame 1016, or after transmitting the second TF 1011 and the first TF 1012, the AP 1010 may switch to operate at P80.

In response to the receipt of the TF 1031, the infra STAs 1030 transmit the UHR preamble 1036 with the TB PPDU 1037 to the AP 1010 on P80. AP 1010 receives the UHR preamble 1036 with the TB PPDU 1037 as a TB PPDU 1017. In response to the receipt of the TB PPDU 1017, the AP 1010 transmits the ACK/BA 1018 to the infra STAs 1030.

In response to the receipt of the first TF 1022, P2P STAs 1020 transmit the UHR preamble 1025 with P2P traffic (PPDU) 1026 on S80. In some embodiments, the P2P STAs 1020 transmit the ACK/BA 1027 at the end of the P2P communication. P2P STAs 1020 may be expected to use enough padding data to make sure that the duration of the P2P communications is aligned with or confined within the TXOP duration or the duration of the infra communication.

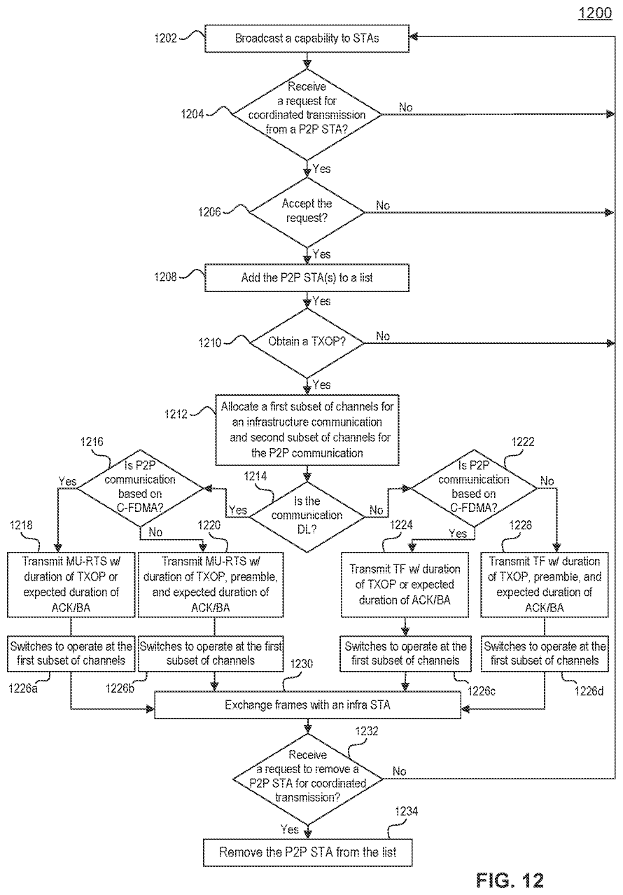

FIG. 12 illustrates a method 1200 for a STA performing infrastructure and P2P medium access, according to some embodiments of the disclosure. For explanation purposes and not a limitation, method 1200 may be described with reference to elements from other figures in the disclosure. For example, method 1200 may be performed by an AP, including but not limited to the AP 110, the AP 310, the AP 410, the AP 510, the AP 610, the AP 710, the AP 810, the AP 910, or the AP 1010. The AP may communicate with P2P STA(s) including but not limited to the P2P STA 122, the P2P STA 124, the P2P STA 322, the P2P STA 324, the P2P STAs 420, the P2P STAs 520, the P2P STAs 620, the P2P STA 722, the P2P STA 724, the P2P STA 822, the P2P STA 824, the P2P STAs 920, and/or the P2P STAs 1020. The AP may communicate with infra STA(s) including but not limited to the infra STA 132, the infra STA 134, the infra STA 332, the P2P STAs 430, the infra STAs 530, the infra STAs 630, the infra STA 732, the infra STA 734, the infra STA 832, the infra STAs 930, and/or the infra STAs 1030.

At operation 1202, the AP broadcasts a capability for a coordinated transmission to P2P STAs (e.g., operation 342 of FIG. 3 or operation 842 of FIG. 8.)

At operation 1204, the AP checks whether the AP receives a request for the coordinated transmission (e.g., operation 344 of FIG. 3, or operation 844 of FIG. 8.) If no, the operation returns to operation 1202.

At operation 1206 (“Yes” at operation 1204,) the AP determines whether the AP accepts the request and transmits ACK to the P2P STA (e.g., operation 344 of FIG. 3, or operation 844 of FIG. 8.) If no, operation returns to operation 1202.

At operation 1208 (“Yes” at operation 1206,) the AP adds the P2P STA(s) to a list (e.g., operation 348 of FIG. 3, or operation 848 of FIG. 8.)

At operation 1210, the AP checks whether the AP obtained a TXOP. If no, the operation returns to operation 1202.

At operation 1212 (“Yes” at operation 1210,) the AP allocates a first subset of channels for infra communications and a second subset of channels for P2P communications (e.g., operation 348 of FIG. 3, or operation 848 of FIG. 8.)

At operation 1214, the AP determines whether the infra communications is DL (Yes) or UL (No).

At operation 1216 (“Yes” at operation 1214,) the AP determines whether the P2P communications are based on C-FDMA (Yes) or C-OFDMA (No).

At operation 1218 (“Yes” at operation 1216,) the AP transmits a first MU-RTS frame to the P2P STAs and a second MU-RTS frame to the infra STAs. In some embodiments, the first MU-RTS frame and the second MU-RTS frame may indicate a duration or an end of a TXOP. In some embodiments, the first MU-RTS frame and the second MU-RTS frame may indicate an expected duration of ACK/BA transmitted by the P2P STA (e.g., operation 350 and operation 352 of FIG. 3, the first MU-RTS frame 412 and the second MU-RTS frame 411 in FIG. 4, or the first MU-RTS frame 512 and the second MU-RTS frame 511 in FIG. 5.) In some embodiments, the first MU-RTS frame may indicate a duration of/end of a DL PPDU (e.g., DL-FDMA PPDU) to enable P2P STAs to align the end of a P2P Traffic at the same time as the infrastructure communications.

At operation 1226a, the AP that has reserved a wide BW (e.g., 160 MHZ) switches transceiver operations to operate at the first subset of the channels (e.g., P80) and stops operation at the second subset of the channels (e.g., S80) during the TXOP.

At operation 1230, the AP exchanges frames with the infra STAs. (e.g., operation 358 of FIG. 3, operation 858 of FIG. 8, DL-PPDU 418 of FIG. 4, DL PPDU 518 of FIG. 5, DL PPDU 617 of FIG. 6, TB PPDU 916 of FIG. 9, or TB PPDU 1017 of FIG. 10.)

At operation 1232, the AP checks whether the AP receives a request to remove the P2P STAs for the coordinated translation (e.g., operation 364 of FIG. 3, or operation 864 of FIG. 8.) If no, the operation returns to operation 1202.

At operation 1234 (“Yes” at operation 1232,) the AP removes the P2P STA from the list (e.g., operation 366 of FIG. 3, or operation 866 of FIG. 8.)

At operation 1220 (“No” at operation 1216,) the AP transmits a first MU-RTS frame to the P2P STAs and a second MU-RTS frame to the infra STAs. In some embodiments, the first MU-RTS frame and the second MU-RTS frame may indicate a duration or an end of a TXOP. In addition, the first MU-RTS frame and the second MU-RTS frame indicate the duration of a preamble of a C-OFDMA PPDU. In addition, the first MU-RTS frame and the second MU-RTS frame may indicate the duration of the C-OFDMA PPDU and/or an expected duration of ACK/BA transmitted by the P2P STA (e.g., operation 350 and operation 352 of FIG. 3, the first MU-RTS frame 412 and the second MU-RTS frame 411 in FIG. 4, and the first MU-RTS frame 612 and the second MU-RTS frame 611 in FIG. 6.)

At operation 1226b, the AP that has reserved a wide BW (e.g., 160 MHZ) switches transceiver operations to operate at the first subset of the channels (e.g., P80) and stops operation at the second subset of the channels (e.g., S80) during the TXOP. Method 1200 returns to operation 1230.

At operation 1222 (“No” at operation 1214,) the AP determines whether the P2P communications are based on C-FDMA (Yes) or C-OFDMA (No).

At operation 1224 (“Yes” at operation 1222,) the AP transmits a first TF to the P2P STAs and a second TF to the infra STAs. In some embodiments, the first TF and the second TF may indicate a duration or an end of a TXOP. In some embodiments, the first TF and the second TF indicate an expected duration of ACK/BA transmitted by the P2P STA (e.g., operation 850 and operation 852 of FIG. 8, the first TF 912 and the second TF 911 in FIG. 9, and the first TF 1012 and the second TF 1011 in FIG. 10.) In some embodiments, the first TF may indicate a duration of/end of a DL PPDU (e.g., DL-FDMA PPDU) to enable P2P STAs to align the end of a P2P Traffic at the same time as the infrastructure communications.

At operation 1226c, the AP that has reserved a wide BW (e.g., 160 MHZ) switches transceiver operations to operate at the first subset of the channels (e.g., P80) and stops operation at the second subset of the channels (e.g., S80) during the TXOP. Method 1200 returns to 1230. Method 1200 returns to operation 1230.

At operation 1228 (“No” at operation 1222,) the AP transmits a first TF to the P2P STAs and a second TF to the infra STAs. In some embodiments, the first MU-RTS frame and the second MU-RTS frame may indicate a duration or an end of a TXOP. In addition, the first TF and the second TF indicate the duration of a preamble of a C-OFDMA PPDU. In addition, the first TF and the second TF may indicate the duration of the C-OFDMA PPDU and/or an expected duration of ACK/BA transmitted by the P2P STA (e.g., operation 850 and operation 852 of FIG. 8, the first TF 912 and the second TF 911 in FIG. 9, and the first TF 1012 and the second TF 1011 in FIG. 10.)

At operation 1226d, the AP switches to operate at the first subset of the channels and stops operation at the second subset of the channels during the TXOP. Method 1200 returns to operation 1230.

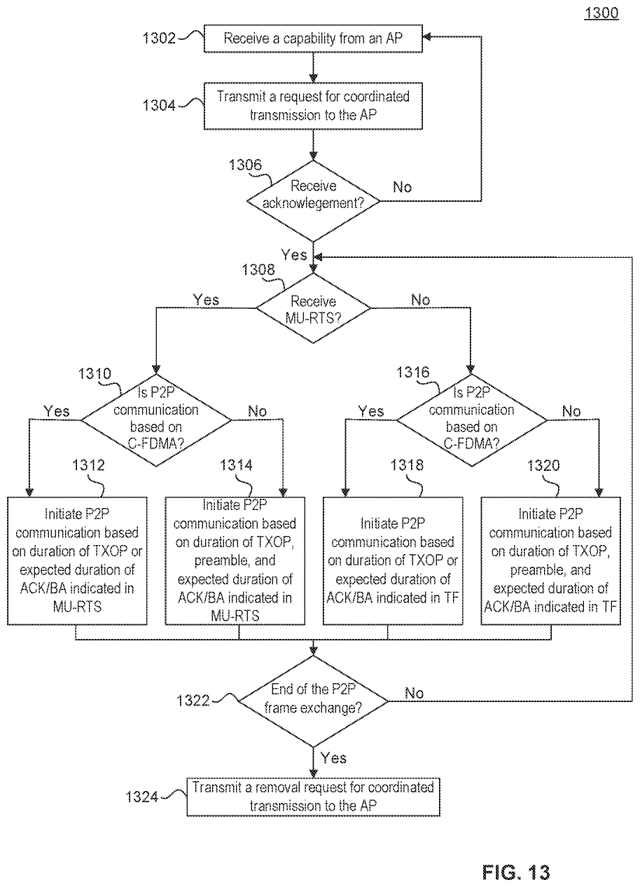

FIG. 13 illustrates a method 1300 for an STA performing infrastructure and P2P medium access sharing, according to some embodiments of the disclosure. For explanation purposes and not a limitation, method 1300 may be described with reference to elements from other figures in the disclosure. For example, method 1300 may be performed by a P2P STA including but not limited to the P2P STA 122, the P2P STA 124, the P2P STA 322, the P2P STA 324, the P2P STAs 420, the P2P STAs 520, the P2P STAs 620, the P2P STA 722, the P2P STA 724, the P2P STA 822, the P2P STA 824, the P2P STAs 920, and/or the P2P STAs 1020. The P2P STA may communicate with an AP, including but not limited to the AP 110, the AP 310, the AP 410, the AP 510, the AP 610, the AP 710, the AP 810, the AP 910, and/or the AP 1010.

At operation 1302, the P2P STA receives a capacity for the coordinated transmission from an AP (e.g., operation 342 of FIG. 3 or operation 842 of FIG. 8.)

At operation 1304, the P2P STA transmits a request for the coordinated transmission to the AP (e.g., operation 344 of FIG. 3, or operation 844 of FIG. 8.) If no, the operation returns to operation 1202. If no, the operation returns to operation 1302.

At operation 1306 (“Yes” at operation 1304,) the P2P STA checks whether the P2P STA receives an acknowledgment from the AP (e.g., operation 346 of FIG. 3, operation 846 of FIG. 8.)

At operation 1308 (“Yes” at operation 1306,) the P2P STA checks whether the P2P STA receives MU-RTS frame (Yes) or TF (No) (e.g., operation 350 of FIG. 3, operation 850 of FIG. 8.)

At operation 1310 (“Yes” at operation 1308,) the P2P STA checks whether P2P communications are based on C-FDMA (Yes) or C-OFDMA (No).

At operation 1312 (“Yes” at operation 1310,) the P2P STA initiates a P2P communication. In some embodiments, the P2P STA may initiate the P2P communications based on a duration or an end of a TXOP indicated in the MU-RTS frame. In some embodiments, the P2P STA may initiate the P2P communications based on an expected duration of an ACK/BA transmitted from the P2P for the P2P communications indicated in the MU-RTS frame. (e.g., operation 350 of FIG. 3, a P2P traffic 425 of FIG. 4, or a first P2P traffic 524 or a second P2P traffic 526 of FIG. 5.)

At operation 1322, the P2P STA checks whether the P2P STA completed the P2P communication. If no, method 1300 returns to operation 1308.

At operation 1324 (“No” at operation 1322,) the P2P STA transmits a removal request for the coordinated transmission to the AP. (e.g., operation 364 of FIG. 3, or operation 864 of FIG. 8.)

At operation 1314 (“No” at operation 1310,) the P2P STA initiates a P2P communication. In some embodiments, the P2P STA may initiate the P2P communications based on the duration of a TXOP and an end of the preamble of PPDU transmitted from AP for an infra communications indicated in the MU-RTS frame. In addition, the P2P STA may initiate the P2P communications based on the duration of the PPDU or an expected duration of an ACK/BA transmitted from the P2P for the P2P communications indicated in the MU-RTS frame. (e.g., operation 350 of FIG. 3, a P2P traffic 425 of FIG. 4, or a P2P traffic 626 of FIG. 6.) Method 1300 returns to operation 1322.

At operation 1316 (“No” at operation 1308,) the P2P STA checks whether P2P communications are based on C-FDMA (Yes) or C-OFDMA (No).

At operation 1318 (“Yes” at operation 1316,) the P2P STA initiates a P2P communication. In some embodiments, the P2P STA may initiate the P2P communications based on a duration or an end of the TXOP indicated in the TF. In some embodiments, the P2P STA may initiate the P2P communications based on an expected duration of an ACK/BA transmitted from the P2P for the P2P communications indicated in the TF. (e.g., operation 850 of FIG. 8, a P2P traffic 1026 of FIG. 10.) Method 1300 returns to operation 1322.

At operation 1320 (“No” at operation 1308,) the P2P STA initiates a P2P communication. In some embodiments, the P2P STA may initiate the P2P communications based on the duration of a TXOP, and an end of the preamble of PPDU transmitted from AP for an infra communications indicated in the TF. In addition, the P2P STA may initiate the P2P communications based on the duration of the PPDU or an expected duration of an ACK/BA transmitted from the P2P for the P2P communications indicated in the TF. (e.g., operation 850 of FIG. 8, a P2P traffic 1026 of FIG. 10.) Method 1300 returns to 1322

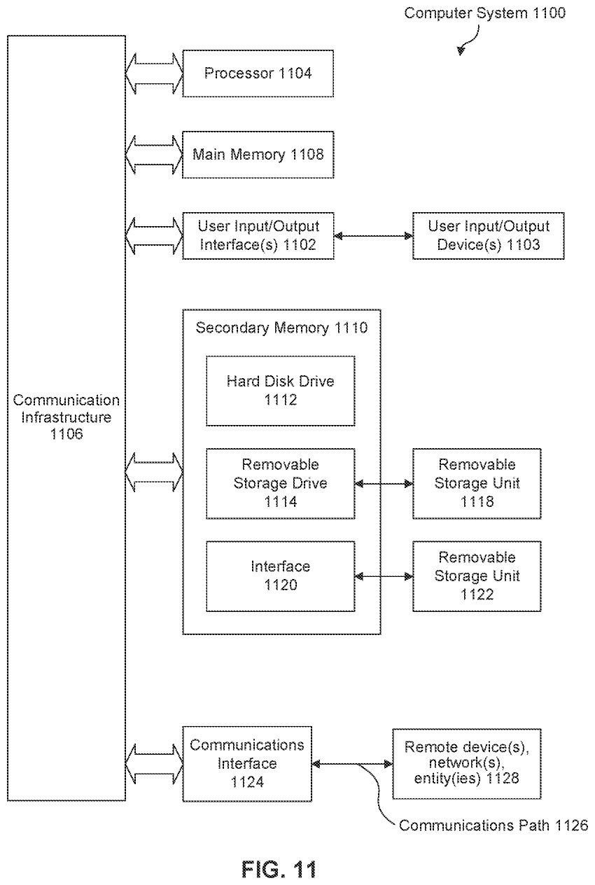

Various embodiments can be implemented, for example, using one or more well-known computer systems, such as computer system 1100 shown in FIG. 11. Computer system 1100 can be any well-known computer capable of performing the functions described herein. For example, and without limitation: the AP 110, the P2P STA 122, the P2P STA 124, the infra STA 132, and the infra STA 134 of FIG. 1, the AP 710, the P2P STA 722, the P2P STA 724, the infra STA 732, and the infra STA 734 of FIG. 7, the system 200 of FIG. 2, the electronic devices of FIGS. 3-6 and 8-10, methods 1200 and 1300 of FIGS. 12 and 13 (and/or other apparatuses and/or components shown in the figures) may be implemented using computer system 1100 or portions thereof.

Computer system 1100 includes one or more processors (also called central processing units, or CPUs), such as a processor 1104. Processor 1104 is connected to a communication infrastructure 1106 that can be a bus. One or more processors 1104 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 also includes user input/output device(s) 1103, such as monitors, keyboards, pointing devices, etc., that communicate with communication infrastructure 1106 through user input/output interface(s) 1102. Computer system 1100 also includes a main or primary memory 1108, such as random access memory (RAM). Main memory 1108 may include one or more levels of cache. Main memory 1108 has stored therein control logic (e.g., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 includes a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 reads from and/or writes to removable storage unit 1118 in a well-known manner.

According to some embodiments, secondary memory 1110 may include other means, instrumentalities or other approaches for allowing computer programs and/or other instructions and/or data to be accessed by computer system 1100. Such means, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 enables computer system 1100 to communicate and interact with any combination of remote devices, remote networks, remote entities, etc. (individually and collectively referenced by reference number 1128). For example, communication interface 1124 may allow computer system 1100 to communicate with remote devices 1128 over communications path 1126, which may be wired and/or wireless, and which may include any combination of LANs, WANs, the Internet, etc. Control logic and/or data may be transmitted to and from computer system 1100 via communication path 1126.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1100, main memory 1108, secondary memory 1110 and removable storage units 1118 and 1122, as well as tangible articles of manufacture embodying any combination of the foregoing. Such control logic, when executed by one or more data processing devices (such as computer system 1100), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 11. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. An access point (AP) comprising:
a transceiver; and
a processor coupled to the transceiver, configured to:
receive a request for coordinated transmission for peer-to-peer (P2P) communications;
determine a bandwidth available for use during a transmit opportunity (TXOP);
allocate, from the bandwidth, a first subset of one or more channels for infrastructure communications and a second subset of one or more channels for the P2P communications; and
transmit, to a station (STA), a first signal corresponding to the second subset of one or more channels for the P2P communications, indicating that the second subset of one or more channels can be used for P2P communications during the TXOP.

2. The AP of claim 1, wherein the infrastructure communications comprise a downlink (DL) physical protocol data unit (PPDU), and the first signal comprises a first trigger frame (TF).

3. The AP of claim 2, wherein the coordinated transmission for P2P communications is based on coordinated-frequency-division multiple access (C-FDMA) and the first TF is a multi-user (MU)-Request to Send (RTS) frame that indicates a duration of the TXOP.

4. The AP of claim 2, wherein the coordinated transmission for P2P communications is based on coordinated-orthogonal frequency-division multiple access (C-OFDMA) and the first TF indicates a duration of a first preamble of the DL PPDU, enabling OFDM-symbol alignment with a second preamble of a P2P PPDU of the P2P communications.

5. The AP of claim 4, wherein the first TF indicates an expected duration of a first acknowledgment (ACK) frame of the P2P communications, wherein the first ACK frame aligns with a second ACK frame of the DL PPDU.

6. A station (STA) comprising:
a transceiver; and
a processor coupled to the transceiver, configured to:
transmit, to an access point (AP), a request for coordinated transmission for peer-to-peer (P2P) communications;
receive, from the AP, a first signal corresponding to a subset of one or more channels for the P2P communications, wherein the first signal indicates that the subset of one or more channels can be used for P2P communications during a transmit opportunity (TXOP); and
initiate the P2P communications using the subset of one or more channels.

7. The STA of claim 6, wherein the first signal is a first trigger frame (TF), the processor is further configured to:
transmit a first Clear to Send (CTS) frame to the AP responsive to the first TF; and
initiate the P2P communications subsequent to the transmission of the CTS frame.

8. The STA of claim 7, wherein the request for coordinated transmission for P2P communications is based on coordinated-frequency-division multiple access (C-FDMA) and wherein the first TF indicates at least one of a duration of the TXOP, the processor is further configured to:
conclude the P2P communications based at least on the duration of the TXOP.

9. The STA of claim 7, wherein the coordinated transmission for P2P communications is based on coordinated-orthogonal frequency-division multiple access (C-OFDMA), and wherein the first TF indicates a duration of a first preamble of a downlink (DL) physical protocol data unit (PPDU) corresponding to infrastructure communications of the AP, the processor is further configured to:
initiate the P2P communications comprising a second preamble that is in OFDM-symbol alignment with the duration of the first preamble.

10. The STA of claim 9, wherein the first TF indicates an expected duration of an acknowledgment (ACK) frame of the P2P communications, the processor is further configured to:
transmit an ACK frame based on the expected duration.

11. The STA of claim 6, wherein the first signal is a multi-user (MU)-Request to Send (RTS) frame, and the processor further configured to:
transmit a first Clear to Send (CTS) frame to the AP; and
initiate the P2P communications in subsequent to the transmission of the CTS frame.

12. The STA of claim 11, wherein the coordinated transmission for P2P communications is based on coordinated-frequency-division multiple access (C-FDMA), and wherein the MU-RTS frame indicates at least one of a duration of the TXOP, the processor is further configured to:
conclude the P2P communications based at least on the duration of the TXOP.

13. The STA of claim 11, wherein the coordinated transmission for P2P communications is based on coordinated-orthogonal frequency-division multiple access (C-OFDMA), and wherein the MU-RTS frame indicates a duration of a first preamble of an uplink (UL) physical protocol data unit (PPDU) corresponding to infrastructure communications of the AP, the processor is further configured to:
initiate the P2P communications comprising a second preamble that is in OFDM-symbol alignment with the duration of the first preamble.

14. The STA of claim 13, wherein the MU-RTS frame indicates an expected duration of an acknowledgment (ACK) frame of the P2P communications, the processor is further configured to:
transmit an ACK frame based on the expected duration.

15. A method for an access point (AP) comprising:
receiving a request for coordinated transmission for peer-to-peer (P2P) communications;
determining a bandwidth available for use during a transmit opportunity (TXOP);
allocating, from the bandwidth, a first subset of one or more channels for infrastructure communications and a second subset of one or more channels for the P2P communications; and
transmitting to a station (STA), a first signal corresponding to the second subset of one or more channels for the P2P communications, indicating that the second subset of one or more channels can be used for P2P communications during the TXOP.

16. The method of claim 15, further comprising:
switching receive operations from the first subset of one or more channels and the second subset of one or more channels to the first subset of one or more channels after transmitting the first signal.

17. The method of claim 15, wherein the infrastructure communications comprise an uplink (UL) physical protocol data unit (PPDU) and the first signal is a first trigger frame (TF).

18. The method of claim 17, wherein the coordinated transmission for P2P communications is based on coordinated-frequency-division multiple access (C-FDMA), and wherein the first TF indicates a duration of the TXOP.

19. The method of claim 17, wherein the coordinated transmission for P2P communications is based on coordinated-orthogonal frequency-division multiple access (C-OFDMA), and wherein the first TF indicates a duration of a first preamble of the UL PPDU, enabling OFDM-symbol alignment with a second preamble of a P2P PPDU of the P2P communications.

20. The method of claim 19, wherein the first TF indicates an expected duration of a first acknowledgment (ACK) frame of the P2P communications, wherein the first ACK frame aligns with a second ACK frame of the UL PPDU.
